(19) United States
(12) Patent Application Publication
(10) Pub. No.: US 2020/0143247 A1
(43) Pub. Date: May 7, 2020

(54) SYSTEMS AND METHODS FOR IMPROVED AUTOMATED CONVERSATIONS WITH INTENT AND ACTION RESPONSE GENERATION

(71) Applicant: Conversica, Inc., Foster City, CA (US)

(72) Inventors: Siddhartha Reddy Jonnalagadda, Bothell, WA (US); Connor Mack Gouge, Seattle, WA (US); Macgregor S. Gainor, Bellingham, WA (US); Ryan Francis Ginstrom, Snohomish, WA (US)

(21) Appl. No.: 16/726,879

(22) Filed: Dec. 25, 2019

Related U.S. Application Data
(63) Continuation-in-part of application No. 16/019,382, filed on Jun. 26, 2018.
Application No. 16/019,382 is a continuation-in-part of application No. 14/604,610, filed on Jan. 23, 2015, now Pat. No. 10,026,037.
Application No. 14/604,610 is a continuation-in-part of application No. 14/604,602, filed on Jan. 23, 2015.
Application No. 14/604,602 is a continuation-in-part of application No. 14/604,594, filed on Jan. 23, 2015.
(60) Provisional application No. 62/785,211, filed on Dec. 26, 2018.
(60) Provisional application No. 62/561,194, filed on Sep. 20, 2017.

(51) Int. Cl. G06N 3/08; G06N 3/04; G06F 40/30; G06F 40/295; G06F 40/284

(52) U.S. Cl. CPC G06N 3/08; G06N 3/0454; G06F 40/284; G06N 3/0445; G06F 40/295; G06F 40/30

(57) ABSTRACT

Systems and methods for generating intents for a response is provided. The tokens of the response is encoded into a dense vector space as a plurality of vectors. Name entities are extracted, and individual sentences and paragraphs are both classified in response to the vectors. In addition to the tokens being represented in the vector space, the sentences and paragraphs may be represented in the vector space. The entities and intents are then used to determine an action for the system according to a policy that is optimized for. Annotations may be requested when the classifications are below thresholds, and these annotations may be employed in the action determination process. Annotation includes receiving an annotation work in an annotation queue, prioritizing the annotations, and sending the highest priority annotations to the annotator in order. This is used to update the production annotation database.

### CROSS REFERENCE TO RELATED APPLICATIONS

This continuation-in-part application is a non-provisional and claims the benefit of U.S. provisional application of the same title, U.S. provisional application No. 62/785,211, Attorney Docket No. CVSC-18J-P, filed in the USPTO on Dec. 26, 2018, currently pending.

This continuation-in-part application also claims the benefit of U.S. application entitled “Systems and Methods for Natural Language Processing and Classification,” U.S. application Ser. No. 16/019,382, Attorney Docket No. CVSC-17A1-US, filed in the USPTO on Jun. 26, 2018, pending, which claims the benefit of U.S. provisional application No. 62/561,194, same title, Attorney Docket No. CVSC-17A-P, filed in the USPTO on Sep. 20, 2017, expired. U.S. application Ser. No. 16/019,283 also is a continuation-in-part application which claims the benefit of U.S. application entitled “Systems and Methods for Configuring Knowledge Sets and AI Algorithms for Automated Message Exchanges,” U.S. application Ser. No. 14/604,610, Attorney Docket No. CVSC-1403, filed in the USPTO on Jan. 23, 2015, now U.S. Pat. No. 10,026,037 issued Jul. 17, 2018. Additionally, U.S. application Ser. No. 16/019,382 claims the benefit of U.S. application entitled “Systems and Methods for Processing Message Exchanges Using Artificial Intelligence,” U.S. application Ser. No. 14/604,602, Attorney Docket No. CVSC-1402, filed in the USPTO on Jan. 23, 2015, pending, and U.S. application entitled “Systems and Methods for Management of Automated Dynamic Messaging,” U.S. application Ser. No. 14/604,594, Attorney Docket No. CVSC-1401, filed in the USPTO on Jan. 23, 2015, pending.

All of the above-listed applications/patents are incorporated herein in their entirety by this reference.

### BACKGROUND

The present invention relates to systems and methods for natural language processing and generation of more “human” sounding artificially generated conversations. Such natural language processing techniques may be employed in the context of machine learned conversation systems. These conversational AIs include, but are not limited to, message response generation, AI assistant performance, and other language processing, primarily in the context of the generation and management of a dynamic conversations. Such systems and methods provide a wide range of business people more efficient tools for outreach, knowledge delivery, automated task completion, and also improve computer functioning as it relates to processing documents for meaning. In turn, such system and methods enable more productive business conversations and other activities with a majority of tasks performed previously by human workers delegated to artificial intelligence assistants.

Artificial Intelligence (AI) is becoming ubiquitous across many technology platforms. AI enables enhanced productivity and enhanced functionality through “smarter” tools. Examples of AI tools include stock managers, chatbots, and voice activated search-based assistants such as Siri and Alexa. With the proliferation of these AI systems, however, come challenges for user engagement, quality assurance and oversight.

When it comes to user engagement, many people do not feel comfortable communicating with a machine outside of certain discrete situations. A computer system intended to converse with a human is typically considered limiting and frustrating. This has manifested in a deep anger many feel when dealing with automated phone systems, or spammed, non-personal emails.

These attitudes persist even when the computer system being conversed with is remarkably capable. For example, many personal assistants such as Siri and Alexa include very powerful natural language processing capabilities; however, the frustration when dealing with such systems, especially when they do not “get it” persists. Ideally an automated conversational system provides more organic sounding messages in order to reduce this natural frustration on behalf of the user. Indeed, in the perfect scenario, the user interfacing with the AI conversation system would be unaware that they are speaking with a machine rather than another human.

In order for a machine to sound more human or organic includes improvements in natural language processing and the generation of accurate, specific and contextual action to meaning rules.

It is therefore apparent that an urgent need exists for advancements in the natural language processing techniques used by AI conversation systems, including contextual analysis by leveraging speech acts, and through the advanced construction of a rule data base populated by sophisticated recommendations. Such systems and methods allow for improved conversations and for added functionalities.

### SUMMARY

To achieve the foregoing and in accordance with the present invention, systems and methods for natural language processing, automated conversations, and enhanced system functionality are provided. Such systems and methods allow for more effective AI operations, improvements to the experience of a conversation target, and increased productivity through AI assistance.

In some embodiments, systems and methods are provided for generating intents for a response. In some cases a number of embeddings are fixed (generally at 300 or more). The tokens of the response is encoded into a dense vector space as a plurality of vectors, with dimensions equal to the number of embeddings. Name entities are extracted and individual sentences and paragraphs are both classified in response to the vectors. In addition to the tokens being represented in the vector space, the sentences and paragraphs may be represented in the vector space.

Classifying the sentence level intents uses a recurrent neural network (RNN), and paragraph level intents uses a different RNN. These recurrent neural networks use Bi-directional Long Short Term Memory (Bi-LSTM). The tokens are encoded using CBOW, Skip-gram or Universal language models.

Sentences that are semantically similar are grouped using K-nearest neighbor algorithm. The RNN can then be trained for classifying the sentence level intents using the grouping of sentences above a threshold number.

in some embodiments, the entities and intents are then used to determine an action for the system. A policy for the conversation is received, and an optimization process for the policy is used to generate the action using a nested Boolean expression, hierarchy of intents, policy gradient algorithms, value iteration algorithms, and reinforcement learning algorithms on sentence level intents, and a conjunctive or disjunctive Boolean expression without nesting for paragraph level intents. The policy gradient algorithm may be A3C, and the value iteration algorithm is a Double Deep Q-Learning Network.

Annotations may be requested when the classifications are below thresholds, and these annotations may be employed in the action determination process (first by sentence level annotations and then by paragraph level annotations). The annotation process may include receiving an annotation work in an annotation queue, prioritizing the annotations, and sending the highest priority annotations to the annotator in order. This is used to update the production annotation database.

The prioritization may be a self-learned process. Annotator interactions may be through an annotation dashboard, such as a MVC web framework. The annotation dashboard interfaces with an annotation tool, such as is a web application accessible by a human annotator. The annotation production database is a relational database, the AI annotation service is a RESTful web service, and the annotation queue is a SQL table. Annotations include entity and intent annotation or a transition annotation.

In some embodiments, it may be important to control versioning in the conversation system. This includes assigning a version date to an original framework component in a chain with other components. When the original framework component is updated, a second version date is applied. Data can be grouped into live data and batch data. Live data is single processed, and if an exception is thrown during this live data processing then the system reverts to an earlier version for the processing. The exception is also noted and used to repair the framework. Batch data is processed in parallel using the repaired framework.

Additionally, the system may enable processing using multiple languages in novel ways. Initially the language of the conversation is detected (using a plurality of models and finding the highest confidence result). The response is then translated from this language to a primary language (often English), which is then used for intent determination, action for the response based on this intent, and then retranslates the action back into the conversation language.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example logical diagram of a system for generation and implementation of messaging conversations, in accordance with some embodiment;

FIG. 2 is an example logical diagram of a dynamic messaging server, in accordance with some embodiment;

FIG. 3 is an example logical diagram of a user interface within the dynamic messaging server, in accordance with some embodiment;

FIG. 4 is an example logical diagram of a message generator within the dynamic messaging server, in accordance with some embodiment;

FIG. 5A is an example logical diagram of a message response system within the dynamic messaging server, in accordance with some embodiment;

FIG. 5B is an example logical diagram of the IntentNet, in accordance with some embodiment;

FIG. 5C is an example logical diagram of an intent based exchange, in accordance with some embodiment;

FIG. 5D is an example flow diagram of a model operation on a message exchange, in accordance with some embodiment;

FIG. 5E is an example logical diagram of an annotation system, in accordance with some embodiment;

FIG. 5F is an example logical diagram of a message delivery handler, in accordance with some embodiment;

FIG. 5G is an example logical diagram of a versioning controller, in accordance with some embodiment;

FIG. 6 is an example flow diagram for a dynamic message conversation, in accordance with some embodiment;

FIG. 7 is an example flow diagram for the process of on-boarding a business actor, in accordance with some embodiment;

FIG. 8 is an example flow diagram for the process of building a business activity such as conversation, in accordance with some embodiment;

FIG. 9 is an example flow diagram for the process of generating message templates, in accordance with some embodiment;

FIG. 10 is an example flow diagram for the process of implementing the conversation, in accordance with some embodiment;

FIG. 11 is an example flow diagram for the process of preparing and sending the outgoing message, in accordance with some embodiment;

FIG. 12 is an example flow diagram for the process of processing received responses, in accordance with some embodiment;

FIG. 13 is an example flow diagram for the process of classification using a knowledge base, in accordance with some embodiment;

FIG. 14 is an example flow diagram for annotation request, in accordance with some embodiment;

FIG. 15 is an example flow diagram for action setting, in accordance with some embodiment;

FIG. 16 is an example flow diagram for handling of alternate languages, in accordance with some embodiment;

FIG. 17 is an example flow diagram for controlling versioning, in accordance with some embodiment; and

FIGS. 18A and 18B are example illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to enhancements to traditional natural language processing techniques and subsequent actions taken by an automated system. While such systems and methods may be utilized with any AI system, such natural language processing particularly excel in AI systems relating to the generation of automated messaging for business conversations such as marketing and other sales functions. While the following disclosure is applicable for other combinations, we will focus upon natural language processing in AI marketing systems as an example, to demonstrate the context within which the enhanced natural language processing excels.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

The following systems and methods are for improvements in natural language processing and actions taken in response to such message exchanges, within conversation systems, and for employment of domain specific assistant systems that leverage these enhanced natural language processing techniques. The goal of the message conversations is to enable a logical dialog exchange with a recipient, where the recipient is not necessarily aware that they are communicating with an automated machine as opposed to a human user. This may be most efficiently performed via a written dialog, such as email, text messaging, chat, etc. However, given the advancement in audio and video processing, it may be entirely possible to have the dialog include audio or video components as well.

In order to effectuate such an exchange, an AI system is employed within an AI platform within the messaging system to process the responses and generate conclusions regarding the exchange. These conclusions include calculating the context of a document, intents, entities, sentiment and confidence for the conclusions. Human operators, through a “training desk” interface, cooperate with the AI to ensure as seamless an experience as possible, even when the AI system is not confident or unable to properly decipher a message, and through message annotation processes. The natural language techniques disclosed herein assist in making the outputs of the AI conversation system more effective, and more ‘human sounding’, which may be preferred by the recipient/target of the conversation.

### I. Dynamic Messaging Systems With Enhanced Natural Language Processing

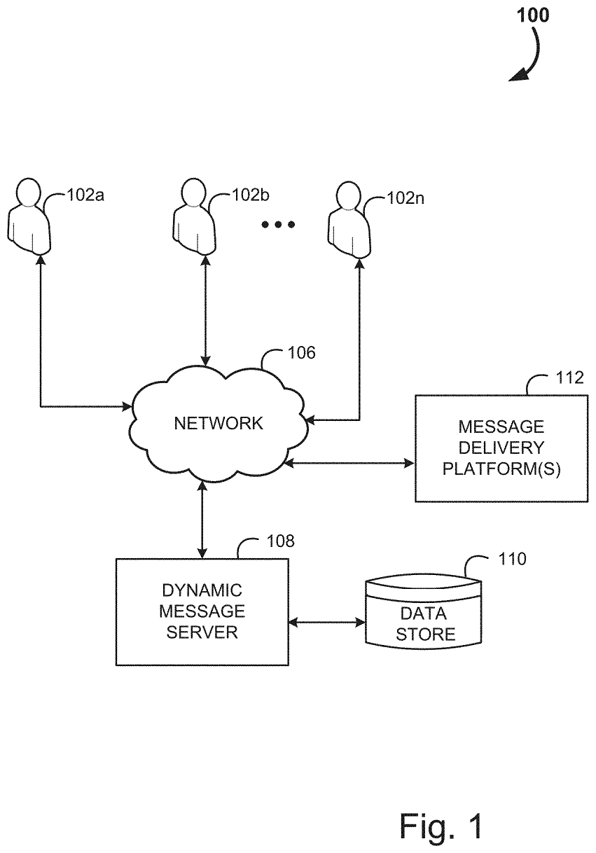

To facilitate the discussion, FIG. 1 is an example logical diagram of a system for generating and implementing messaging conversations, shown generally at 100. In this example block diagram, several users 102a-n are illustrated engaging a dynamic messaging system 108 via a network 106. Note that messaging conversations may be uniquely customized by each user 102a-n in some embodiments. In alternate embodiments, users may be part of collaborative sales departments (or other collaborative group) and may all have common access to the messaging conversations. The users 102a-n may access the network from any number of suitable devices, such as laptop and desktop computers, work stations, mobile devices, media centers, etc.

The network 106 most typically includes the interne but may also include other networks such as a corporate WAN, cellular network, corporate local area network, or combination thereof, for example. The messaging server 108 may distribute the generated messages to the various message delivery platforms 112 for delivery to the individual recipients. The message delivery platforms 112 may include any suitable messaging platform. Much of the present disclosure will focus on email messaging, and in such embodiments the message delivery platforms 112 may include email servers (Gmail, Yahoo, Outlook, etc.). However, it should be realized that the presently disclosed systems for messaging are not necessarily limited to email messaging. Indeed, any messaging type is possible under some embodiments of the present messaging system. Thus, the message delivery platforms 112 could easily include a social network interface, instant messaging system, text messaging (SMS) platforms, or even audio or video telecommunications systems.

One or more data sources 110 may be available to the messaging server 108 to provide user specific information, message template data, knowledge sets, intents, and target information. These data sources may be internal sources for the system's utilization or may include external third-party data sources (such as business information belonging to a customer for whom the conversation is being generated). These information types will be described in greater detail below. This information may be leveraged, in some embodiments, to generate a profile regarding the conversation target. A profile for the target may be particularly useful in a sales setting where differing approaches may yield dramatically divergent outcomes. For example, if it is known that the target is a certain age, with young children, and with an income of $75,000 per year, a conversation assistant for a car dealership will avoid presenting the target with information about luxury sports cars, and instead focus on sedans, SUVs and minivans within a budget the target is likely able to afford. By engaging the target with information relevant to them, and sympathetic to their preferences, the goals of any given conversation are more likely to be met. The external data sources typically relied upon to build out a target profile may include, but are not limited to, credit applications, CRM data sources, public records data sets, loyalty programs, social media analytics, and other “pay to play” data sets, for example.

The other major benefit of a profile for the target is that data that the system “should know” may be incorporated into the conversation to further personalize the message exchange. Information the system “should know” is data that is evident trough the exchange, or the target would expect the AI system would know. Much of the profile data may be public, but a conversation target would feel strange (or even violated) to know that the other party they are communicating with has such a full set of information regarding them. For example, a consumer doesn't typically assume a retailer knows how they voted in the last election, but through an AI conversational system with access to third party data sets, this kind of information may indeed be known. Bringing up such knowledge in a conversation exchange would strike the target as strange, at a minimum, and may actually interfere with achieving the conversation objectives. In contrast, offered information, or information the target assumes the other party has access to, can be incorporated into the conversation in a manner that personalizes the exchange, and makes the conversation more organic sounding. For example if the target mentions having children, and is engaging an AI system deployed for an automotive dealer, a very natural message exchange could include “You mentioned wanting more information on the Highlander SUV. We have a number in stock, and one of our sales reps would love to show you one and go for a test drive. Plus they are great for families. I'm sure your kids would love this car.”

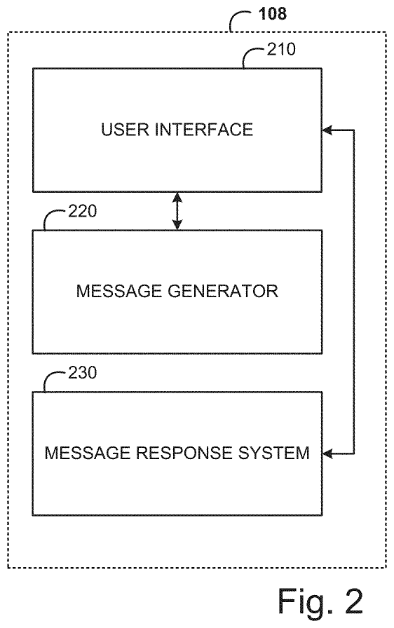

Moving on, FIG. 2 provides a more detailed view of the dynamic messaging server 108, in accordance with some embodiment. The server is comprised of three main logical subsystems: a user interface 210, a message generator 220, and a message response system 230. The user interface 210 may be utilized to access the message generator 220 and the message response system 230 to set up messaging conversations and manage those conversations throughout their life cycle. At a minimum, the user interface 210 includes APIs to allow a user's device to access these subsystems. Alternatively, the user interface 210 may include web accessible messaging creation and management tools.

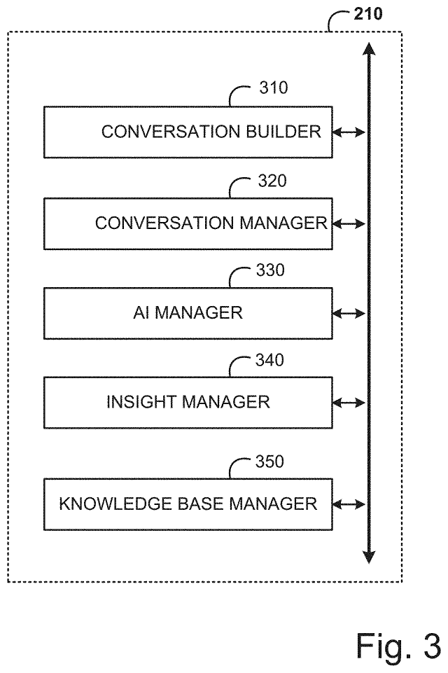

FIG. 3 provides a more detailed illustration of the user interface 210. The user interface 210 includes a series of modules to enable the previously mentioned functions to be carried out in the message generator 220 and the message response system 230. These modules include a conversation builder 310, a conversation manager 320 an AI manager 330, an intent manager 340, and a knowledge base manager 350.

The conversation builder 310 allows the user to define a conversation, and input message templates for each series/exchange within the conversation. A knowledge set and target data may be associated with the conversation to allow the system to automatically effectuate the conversation once built. Target data includes all the information collected on the intended recipients, and the knowledge set includes a database from which the AI can infer context and perform classifications on the responses received from the recipients.

The conversation manager 320 provides activity information, status, and logs of the conversation once it has been implemented. This allows the user 102a to keep track of the conversation's progress, success and allows the user to manually intercede if required. The conversation may likewise be edited or otherwise altered using the conversation manager 320.

The AI manager 330 allows the user to access the training of the artificial intelligence which analyzes responses received from a recipient. One purpose of the given systems and methods is to allow very high throughput of message exchanges with the recipient with relatively minimal user input. To perform this correctly, natural language processing by the AI is required, and the AI (or multiple AI models) must be correctly trained to make the appropriate inferences and classifications of the response message. The user may leverage the AI manager 330 to review documents the AI has processed and has made classifications for.

In some embodiments, the training of the AI system may be enabled by, or supplemented with, conventional CRM data. The existing CRM information that a business has compiled over years of operation is incredibly rich in detail, and specific to the business. As such, by leveraging this existing data set the AI models may be trained in a manner that is incredibly specific and valuable to the business. CRM data may be particularly useful when used to augment traditional training sets, and input from the training desk. Additionally, social media exchanges may likewise be useful as a training source for the AI models. For example, a business often engages directly with customers on social media, leading to conversations back and forth that are again, specific and accurate to the business. As such this data may also be beneficial as a source of training material.

The intent manager 340 allows the user to manage intents. As previously discussed, intents are a collection of categories used to answer some question about a document. For example, a question for the document could include “is the lead looking to purchase a car in the next month?” Answering this question can have direct and significant importance to a car dealership. Certain categories that the AI system generates may be relevant toward the determination of this question. These categories are the ‘intent’ to the question and may be edited or newly created via the intent manager 340. As will be discussed in greater detail below, the generation of questions and associated intents may be facilitated by leveraging historical data via a recommendation engine.

In a similar manner, the knowledge base manager 350 enables the management of knowledge sets by the user. As discussed, a knowledge set is a set of tokens with their associated category weights used by an aspect (AI algorithm) during classification. For example, a category may include “continue contact?”, and associated knowledge set tokens could include statements such as “stop”, “do no contact”, “please respond” and the like.

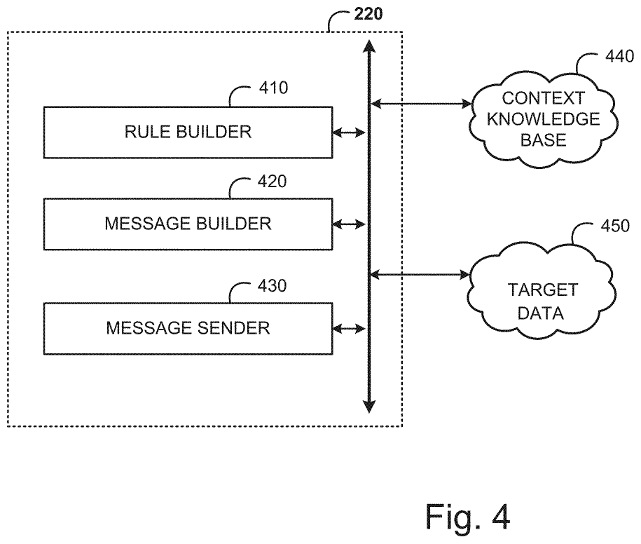

Moving on to FIG. 4, an example logical diagram of the message generator 220 is provided. The message generator 220 utilizes context knowledge 440 and target data 450 to generate the initial message. The message generator 220 includes a rule builder 410 which allows the user to define rules for the messages. A rule creation interface which allows users to define a variable to check in a situation and then alter the data in a specific way. For example, when receiving the scores from the AI, if the intent is Interpretation and the chosen category is ‘good’, then have the Continue Messaging intent return ‘continue’.

The rule builder 410 may provide possible phrases for the message based upon available target data. The message builder 420 incorporates those possible phrases into a message template, where variables are designated, to generate the outgoing message. Multiple selection approaches and algorithms may be used to select specific phrases from a large phrase library of semantically similar phrases for inclusion into the message template. For example, specific phrases may be assigned category rankings related to various dimensions such as “formal vs. informal, education level, friendly tone vs. unfriendly tone, and other dimensions,” Additional category rankings for individual phrases may also be dynamically assigned based upon operational feedback in achieving conversational objectives so that more “successful” phrases may be more likely to be included in a particular message template. Phrase package selection will be discussed in further detail below. The selected phrases incorporated into the template message is provided to the message sender 430 which formats the outgoing message and provides it to the messaging platforms for delivery to the appropriate recipient.

Feedback may be collected from the conversational exchanges, in many embodiments. For example if the goal of a given message exchange is to set up a meeting, and the target agrees to said meeting, this may be counted as successful feedback. However, it may also be desirable to collect feedback from external systems, such as transaction logs in a point of sales system, or through records in a CRM system.

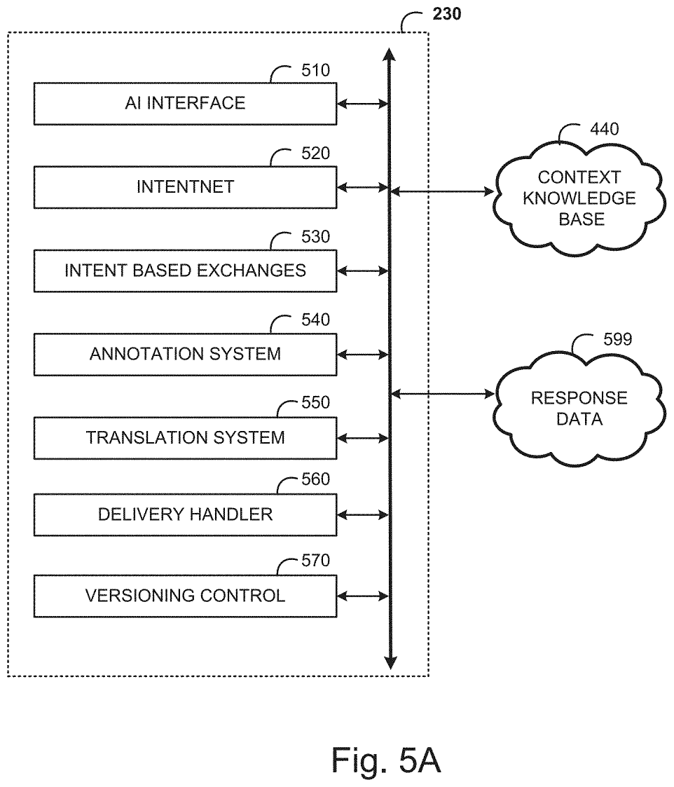

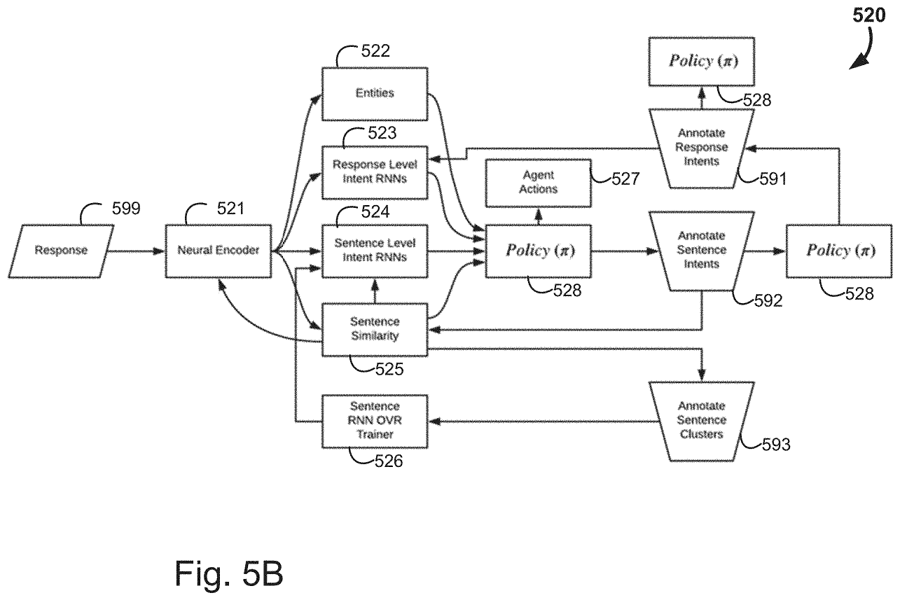

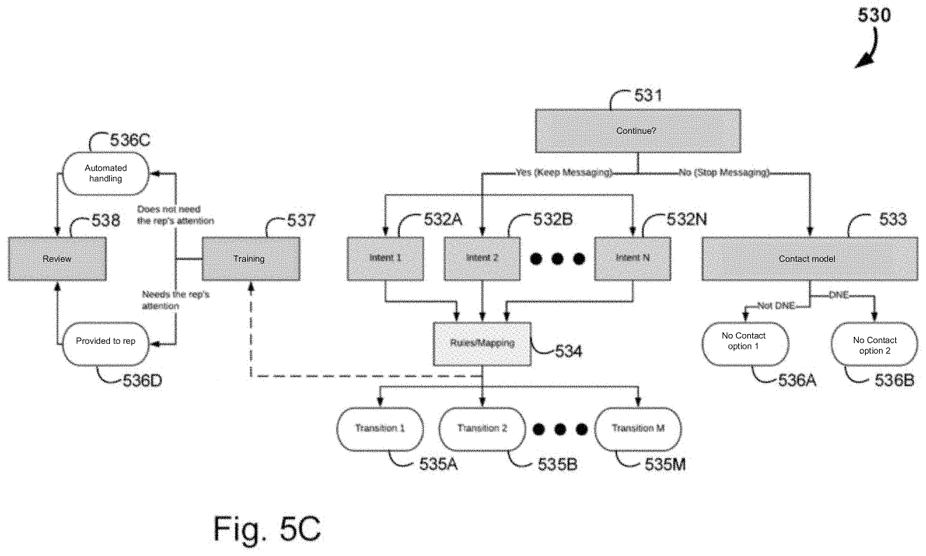

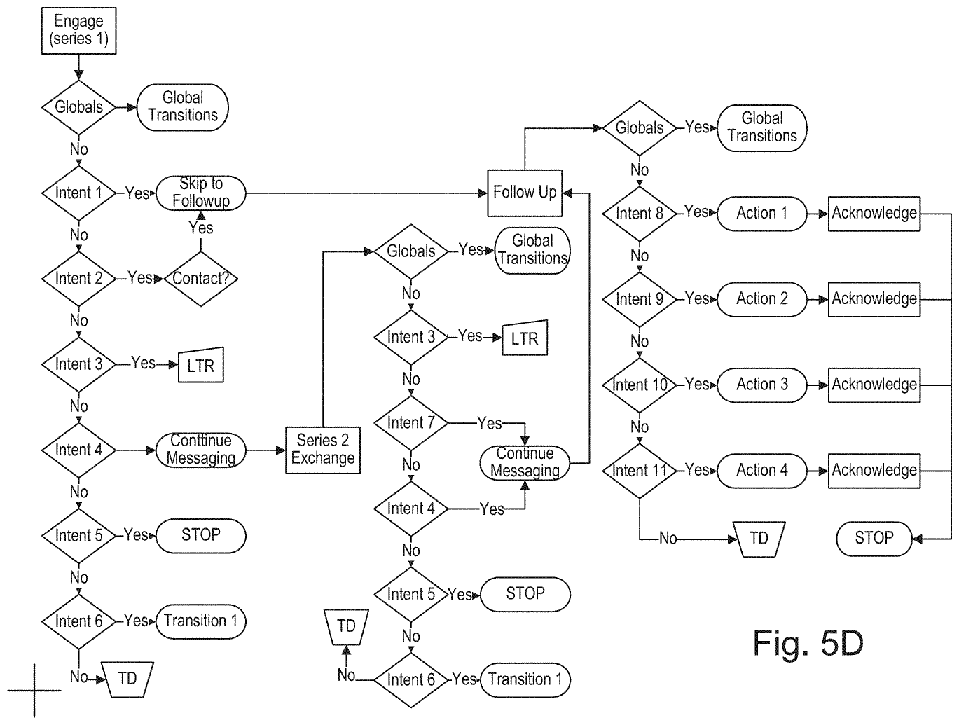

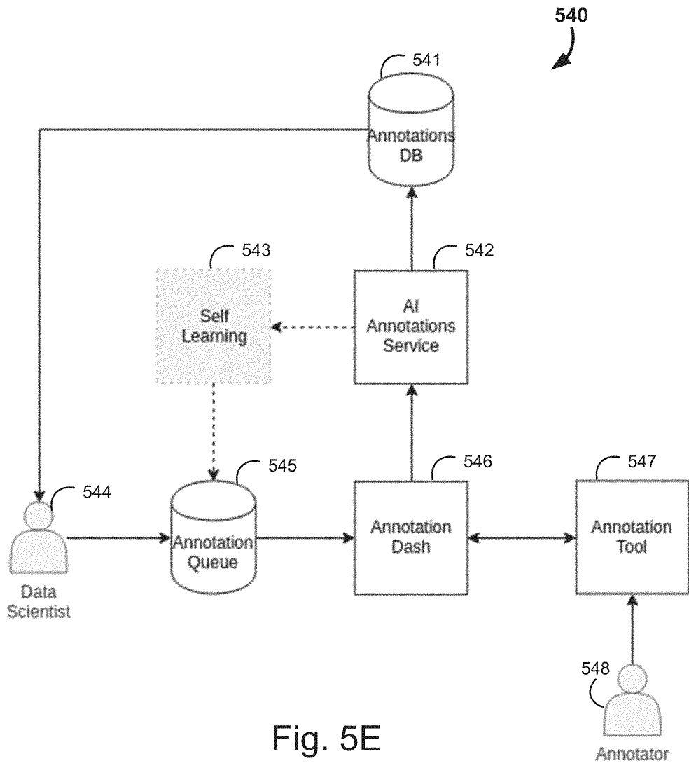

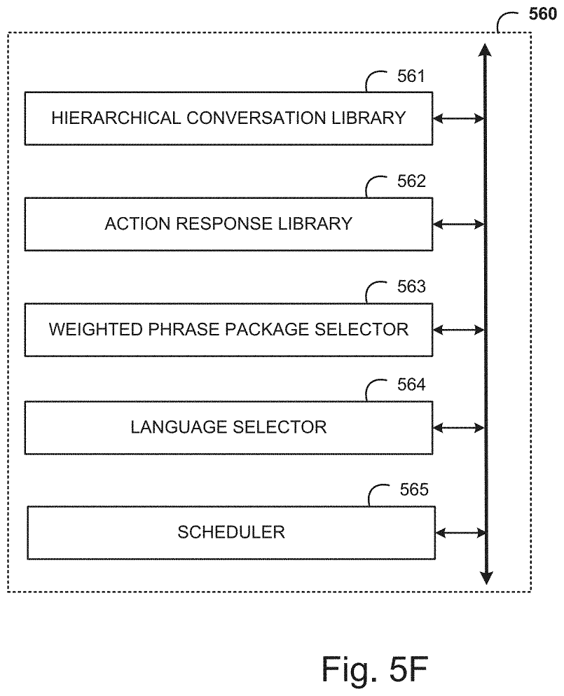

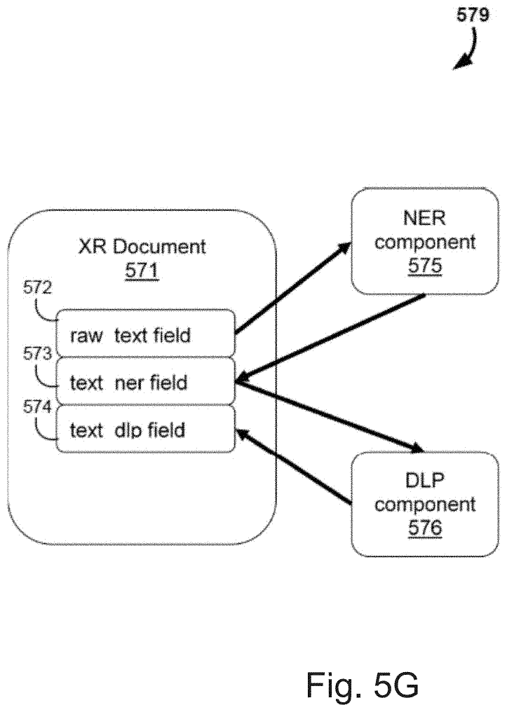

FIG. 5A is an example logical diagram of the message response system 230. In this example system, the contextual knowledge base 440 is utilized in combination with response data 599 received from the person being messaged (the target or recipient). The AI interface 510 receives the response data 599 and provides it to the other system components for processing. This processing may include a suite of tools that enable classification of the messages using machine learned models, and based on the classifications generated by the AI and classification tools, target objectives may be updated and the subsequent actions to be taken may be determined. A scheduler and message delivery handler 560 may coordinate the execution of these determined activities, and interface with third party email systems to deliver response messages.

The message delivery handler 560 enables not only the delivery of the generated responses, but also may effectuate the additional actions beyond mere response delivery. The message delivery handler 560 may include phrase selections, contextualizing the response by historical activity, through language selection, and execute additional actions like status updates, appointment setting, and the like.

The processing of the message may be performed by an IntentNet 520 that leverages neural encoding to analyze the received response and determine various level intents for the responses. Together with policies, these intents are used to determine actions, request annotations and update objectives for the conversation. An intent based exchange 530 is the system responsible for using the identified intents to determine the precise action to be taken. Likewise, and annotation system 540 allows for the improvement of training data using annotation services.

Not all conversations take place in English. One method of handling multiple languages is to mirror models and systems across different language datasets. This method can be computationally cumbersome, require massive training datasets, requires difficult transitions when a conversation needs to switch between languages, and may result in very different accuracy measures based upon the language employed and the corresponding training data available for that language. For this reason, rather than multiple systems running for each language, the system may include a translation system 550 that enables the core model backbone to operate on a wide variety of input languages.

Lastly, a versioning controller 570 enables the tracking of versions, such that when a new version of a particular model or other system component is deployed, the system can readily revert to earlier operational states in the event of an error. Thus the system may operate without interruption, when viewed from the target's perspective, regardless of backend updates.

Many of the aforementioned system components benefit from collecting detailed information from existing external systems within an organization (or more globally). A scraper (not illustrated) enables the collection of these data streams to allow these systems to operate more effectively.

Turning to FIG. 5B, the IntentNet 520 is presented in greater detail. Prior to any processing, the response 599 may be subject to any number of preprocessing activities, such as parsing, normalization and error corrections. For example, a parser (not illustrated) could consume the raw message and splits it into multiple portions, including differentiating between the salutation, reply, close, signature and other message components, for example. Likewise, a tokenizer may break the response into individual sentences and n-grams.

After any such pre-processing, a neural encoder 521 processes the response to define response level intents 523, sentence level intents 524, entity recognition 522 and identifies similarity between sentences 525. Traditionally, it has proven difficult to perform inferencing and reasoning only based on conversation inputs primarily based on neural encoding of text or speech. Neural approaches to conversational AI that use end-end learning and traditional approaches to conversational AI systems are not accurate enough to be used in practice. The practical systems that focus on intents in a narrow domain are not capable of general intelligent behavior for conversations. However, non-neural encoding techniques to conversational AI processing involve too many steps in the pipeline, resulting in errors from the earlier steps being magnified in the subsequent steps.

The present system addresses this shortcoming by encoding natural language as intents and named entities and performing natural language generation based on the value of intents and entities. Particularly, an end-end neural approach is used where multiple components are stacked within a single deep neural network. These components include an encoder, a reasoner and a decoder. This differs from traditional AI systems which usually ingle a speech recognition model, word-level analytics, syntactical parsing, information extractors, application reasoning, utterance planning, syntactic realization, text generation and speech synthesis.

In the present neural encoder 521, the encoding portion represents the natural language inputs and knowledge as dense, high-dimensional vectors using embeddings, such as dependency-based word embedding and bilingual word embeddings, as well as word representations by semi-supervised learning, semantic representations using conventional neural networks for web search, and parsing of natural scenes and natural language using recursive neural networks.

The reasoner portion of the neural encoder 521 classifies the individual instance or sequence of these resulting vectors into a different instance or sequence typically using supervised approaches such as convolutional networks (for sentence classification) and recurrent networks (for the language model) and/or unsupervised approaches such as generative adversarial networks and auto-encoders (for reducing the dimensionality of data within the neural networks).

Lastly, the decoders of the neural encoder 521 converts the vector outputs of the reasoner functions into symbolic space from which encoders originally created the vector representations. In some embodiments the neural encoder 521 may include three functional tasks: natural language understanding (including intent classification and named entity recognition), inference (which includes learning policies 528 and implementation of these policies appropriate to the objective of the conversation system using reinforcing learning or a precomputed policy), and natural language generation (by taking into account an action/decision made based upon the intent and incorporating AI models for emotion and knowledge sets).

The neural encoder 521 accomplishes these tasks by automatically deriving a list of intents that that describe a conversational domain such that for every response from the user, the conversational AI system is able to predict how likely the user wanted to express intent, and the AI agent's policy (it) 528 can be evaluated using the intents and corresponding entities 522 in the response to determine the agent's action 527. This derivation of intents uses data obtained from many enterprise assistant conversation flows. Each conversation flow was designed based on the reason for communication, the targeted goal and objectives, and key verbiage from the customer to personalize the outreach. These conversation flows are subdivided by their business functions (e.g., sales assistants selling automobiles, technology products, financial products and other products, service assistants, finance assistants, customer success assistants, collections assistants, recruiting assistants, etc.).

The response 599, as discussed, is natural language text or speech from the human to AI. The neural encoding network 521 uses word embedding models first to encode each token into a vector in a dense high-dimensional vector space. In some embodiments, 300 or more dimensions may be utilized. The network is extended to also represent sentences and paragraphs of the response in the vector space. These encodings are passed to a set of four models. The first model extracts named entities 522 across all the sentences in the utterance. Next, a recurrent neural network (RNN) classifies intents at paragraph-level 523. Thirdly, a different recurrent neural network uses the outputs of neural encoder and classifies the individual sentences into intents 524. The sentence-level intents and paragraph-level intents share the taxonomy but have a distinct set of labels. Fourth, a K-nearest neighbor algorithm is used on sentence representation to group semantically identical (or similar) sentences 525. When a cluster of semantically similar groups 593 is big enough, the corresponding RNN model is trained via a trainer 526 for the groups and creates a new sentence intent RNN network and add it the set of sentence intents 524 if bias and variance are low.

The outputs of each of the models represent the state of the environment is shared with the agent in a reinforcement learning setting. The agent applies the policy (it) 528 to optimize the reward and decide the action 527. If the action is not inferred with a suitable threshold of confidence, an annotation platform requests annotation of sentence intents 592 using active learning. The policy (it) is then applied again based on the new information. If the action cannot still be inferred based on the updated state, the intents that are necessary at paragraph-level for policy (it) are annotated 591 to be able to decide the appropriate action 527.

The neural encoder 521 accepts as input a natural language text or audio or video and outputs a vector that best represents the text in a high-dimensional vector space. The number of embeddings is fixed in advance (e.g. 300). In the case of text, each response is split into sentences and each sentence is tokenized into words. Each word (wᵢ) is assigned a vector (v_{w}_{ᵢ}) such that words that are distributionally similar to each other based on the context around them have similar vectors. Algorithms such as CBOW, Skip-gram, and Universal language models are utilized in this process. Word vector models seek to assign vectors in such a way that the context (c) word(s) can be used to determine the target words (t) among all the possible pairs T. The context (c) is typically made of multiple words before and after the target (t). The target (t) are the word(s) that in the middle of the context or words around the context. That is, the word vector models seek to maximize the average log probability

$$\frac{1}{T}$$

log log log p(t|c) using multiclass classifiers such as hierarchical softmax.

Once each word (wᵢ) is assigned a vector (v_{w}_{ᵢ}), vectors are assigned to any arbitrary paragraph (p) by averaging the vectors of the words or by using the Paragraph2Vec algorithm. The similarity between two paragraphs (pᵢ and pⱼ) is calculated either using vector similarity or using a deep siamese recurrent neural network (so named because of its effectiveness to recognize twin images). That is, if the corresponding vectors are vₚᵢ and vₚⱼ and the similarity measure used is cosine, the vector similarity between pᵢ and pⱼ is given by:

$$\frac{{v}_{{p}_{i }} \cdot {v}_{{p}_{j}}}{‖ {v}_{{p}_{i}} ‖ ‖ {v}_{{p}_{j}} ‖}$$

For the deep Siamese recurrent neural network, vₚᵢ and vₚⱼ are fed to identical recurrent neural networks such as long short term memory (LSTM) network followed by a deep feedforward layer and the output of both network is passed to sigmoid layer. The network is trained by the sentence intents obtained in the subsequent stages. The LSTM network of the deep Siamese network along with the weights are also used for sentence similarity.

The next set of models take as input the neural encodings of natural language such as the neural encoder for text described above. The named entities are extracted using recurrent neural network that accept the sequences of word embeddings as inputs and output whether a word is inside or outside or at the beginning or at the end. There are several open-source datasets such as OntoNotes and CoNLL for named entities. Since the type of named entities such as person, organization, location, time and product that need neural models have open source implementations, it is possible to also used tools such as spaCy and Stanford CoreNLP for this extraction. Intents are extracted using the paragraph-level intent classifiers and sentence-level intent classifiers.

Paragraph-level intents are expected to have a more direct relationship with the actions taken by the reinforcement learning agent and are at a higher level. They are intents that are less generalizable across all assistants but are more accurate for the specific use cases for which they are applicable. The network architecture for paragraph-level intents uses Bi-directional Long Short Term Memory (Bi-LSTM) with vector encodings for words as input and classification encoding as the output. Paragraph intents are annotated in the annotation workflow when sentence level intents and entities are not able to convey enough information to the reinforcement learning agent to be able to take an action.

Sentence-level Intents, on the other hand, are more general and they capture the context and semantics of natural language at a more granular level. Sentence-level intents are classified using a Bi-LSTM approach similar to that used in paragraph-level intents or using a vector similarity approach. The sentence-level intents are initially classified using vector similarity approaches. A combination of topic modeling and unsupervised clustering on n-grams and linguistic attributes such as noun phrases and verbs are used. In addition, the vectors derived from deep Siamese network for paragraph similarity or the network directly may be used to determine the similarity.

When a sentence group (the group of sentences that are considered semantically similar by the above algorithm) is sufficiently big/large enough based upon a preset threshold, a sentence-level classifier is trained using a recurrent neural network such as Bi-LSTM and the model is adding to sentence-level intents. Until then, the classification of that group of intents happens using sentence similarity approaches that are equivalent to K-Nearest Neighboring algorithm.

As discussed previously, the system first annotates sentence level intents through humans in the loop when the policy (π) is unable to determine the artificial intelligence system's action automatically extracted intent pairs. Since there are a combinatorically large number of sentence-intent pairs that need to be annotated in the worst case, it is still possible that based on the entities, sentence-level and paragraph-level intents extracted automatically and sentence-level intents manually annotated are insufficient for the policy (π) to determine the artificial intelligence system's action. In such a case, the paragraph-level intents that are needed to be able to apply policy (π) are processed in the annotation workflow. Sentence-level intents are expected to be granular, more in number, and many sentence-level intents can be associated with an action determined by policy (π) through a nested Boolean expression, hierarchy of intents, policy gradient algorithms such as A3C, value iteration algorithms such as Double Deep Q-Learning Networks, and other reinforcement learning algorithms. Paragraph-level intents are expected to be higher-level, lesser in number, and typically 1-4 paragraph-level intents combined along with entities through a conjunctive or disjunctive Boolean expression without nesting suffices for policy (π) to determine an action.

FIG. 5C provides an example intent based exchange 530, where a series of intent based models are reused across conversations to determine the actions to be taken as part of the IntentNet 520. The model associated with determining if a further action is needed 531 is a shared model across all conversations. If so, the model used to decide if contact should be terminated 533 is likewise universal across various exchanges and conversations. The resulting action is either to stop messaging 536a, or to cease all contact 536b.

If however, additional actions are determined as desirable by the model 531, a series of intents are determined 532a-n as discussed previously. These intents are determined as discussed previously, and may be shared across all exchanges and conversations. Where the models diverge between conversations is how these intents map 534 to specific actions. The result of the actions results in that state of the conversation updating via a state transition 535a-m.

If despite paragraph level intent annotation there is still a lack of confidence on what action to take, or if no action applies in the rules, the system may divert the response to a manual review at a training desk 537 where a decision is made if there actually is an action that would apply to the exchange 536c or if a new action is needed and a representative needs to attend 536d to the response. In either case, a manual review and analysis is performed by a user 538 to modify system behavior to correct for future events.

Turning now to FIG. 5D, an example flow diagram is provided for the processing of a message exchange using a large agreement model. In this example, the system initially engages with the target (a series 1 in the conversation). The response of which is classified as discussed herein to identify a global transition event, such as an out of office event, etc. If this were found the conversation enters an appropriate transition. Next, a positive intent which indicates the system should continue to the objective is looked for. If it isn't present, another intent related to interest is identified. If it is present the system, the next step may be to skip to the follow-up objective, if there is contact information present.

If there is no appropriate intent, an intent is looked for that relates to any of a given number of actions. If found the action is taken. Otherwise, the system looks for indicators continue messaging and then to stop messaging, and if not present finally provides the response to specialized AI models for analysis and transitions. If even these models fail to identify a suitable transition, the response may be provided to a training desk for review.

If the system identified an intent to continue messaging the next message series in the conversation is sent and a response collected. Again the message response is reviewed for global transitions, action intents, one or more intents to continue messaging, stop messaging intents, and specialized AI models. Upon an intent to continue the messaging (or if before there was a skip to the follow-up objective) the follow-up is performed. Again, the response is then reviewed for global transitions, and a series of objective resolution intents are identified (indicating the various outcomes of the follow-up exchange). These resolutions intents are acknowledged, and the conversation ends.

FIG. 5E provides greater detail of the annotation system 540 used by the above components. The above described intent based taxonomy requires an efficient annotation loop in order to be effective. Annotation projects take time to coordinate and execute. In order to deliver intents at scale, data scientists need tools to manage annotation priority according to classifier performance and business requirements. Additionally annotators must be able to easily access the highest priority tasks.

An annotation queue 545 enables data scientists 544 to post annotation work from an annotation database 541 for processing. The queue 545 captures prioritization data and the type of annotation required. Project or intent filters may be applied to the queue 545 to limit the scope for specific annotation workflows. In some cases a SQL table can be used for queue implementation. A queue-broker is not necessary given the queue read/write bandwidth requirements. Table locking can be used as a mechanism to enforce queue message delivery without having an impact on system performance. The usage of the annotation queue provides the benefits of reducing manual overhead of intent-project creation, annotation task priority is self-documenting, annotation tasks are continuously delivered to annotators, and non-annotated documents can be represented by the AI-annotation database schema (a relational database storing the structured annotation relations and the human annotation metrics).

Annotators 548 continually consume the highest priority documents/responses from the queue 545 via an annotation tool 547. The annotation tool 547 may include any web application used to collect human-annotated documents. The annotation dashboard 546 may include a model view controller (MVC) web framework for php (hypertext preprocessor), which is used to organize and host the administrative tools such as the annotation tool 547.

The AI annotation service 542 may be a RESTful web service which acts as an interface to production annotation database 541. The self-learning 543 processor automatically prioritizes annotation tasks and uploads tasks for integration with existing annotation tools.

In this annotation system, having a human in the loop allows administrative users to specify a selected transition for a lead in a conversation, given a response. As a result of human intervention, a transition annotation is collected. Transition annotations can be used to build a transition classifier for a single exchange; however, the annotation may not provide value outside of the associated conversation exchange.

Human intervention may be employed to annotate intent and entity values such that a valid transition can always be produced by inference engine rules. In contrast, the inference engine rules may be altered via human interaction if the decision for a transition is annotated given a set of intents and entities. Annotation of the intents and entity values correlates annotations directly with intents and entities. This allows for continuous improvement of all exchanges depending on the particular intent, and does not require significant contextual knowledge of the use-case by the annotator. Lastly, this approach allows labels that need to be annotated will be automatically learnt from the intents variables in the inference policies set up for the transitions. Such annotation requires more human involvement than annotation of inference engine rules, however.

Thus, for internal system annotations, it is generally more desirable to engage in intent and entity annotation processes (despite the larger human burden) due to the lack of needing use case knowledge and the continual improvement elements. However, for client facing annotation processes, since the use case contextual knowledge is known, the lower degree of human involvement favors rule annotation.

After the smart parser 521 is a language detector 522 which detects the language used in the raw text resulting from the smart parser 521. This language test is run against multiple language models, and the highest scoring model is selected as the model language. A binary confidence level- either ‘confident’ or ‘not confident’ is also output if the model score is above a configured threshold.

After language detection, a tokenizer 523 divides the raw text into individual sentences. The motivation behind this preprocessing is to divide the prospect's response into separate ideas (usually indicated grammatically by sentences) and later predict meanings/intends at the more granular sentence level. This prevents the words/grams/features in one idea from contaminating/creating noise in the prediction of a second idea.

Subsequent to the tokenization, a normalizer 524 generates three new variables for the message. These include a classified text, clean text and the raw text. These different versions are each consumed in later operations. To make the best predictions of intents and meanings in the message, the system should eliminate possible sources of noise. Logic relating to lowercase strings, splitting the text into tokens, looking for entities with special expressions, replacement of these entities with special elements, removal of stop words, removal of intelligens stopwords, and string normalization results in the return of classification text. Once the normalization process is completed a new clean string is generated to be sent to the next step plus other variables that may be stored.

After the raw text has been received and pre-processed in the above manner, the data processor 530 performs the main analysis on the message data. The data processor 530 is provided in greater detail in relation to FIG. 5C. In this component, data is processed to build features for classification text—these are standard text and language features: ngrams, stems and POS tags. The data processor includes an initial function (not illustrated) which, in some embodiments, may utilize a tagger from Stanford API, all included in the lambda function. This data processor function also contains a tagger for each of the supported languages.

Turning to FIG. 5F, the message delivery handler 560 is presented in greater detail. The message delivery handler 560 receives output from the earlier components and performs its own processing to arrive at the final outgoing message. The message delivery handler 560 may include a hierarchical conversation library 561 for storing all the conversation components for building a coherent message. The hierarchical conversation library 561 may be a large curated library, organized and utilizing multiple inheritance along a number of axes: organizational levels, access-levels (rep->group->customer->public). The hierarchical conversation library 561 leverages sophisticated library management mechanisms, involving a rating system based on achievement of specific conversation objectives, gamification via contribution rewards, and easy searching of conversation libraries based on a clear taxonomy of conversations and conversation trees.

In addition to merely responding to a message with a response, the message delivery handler 560 may also include a set of actions that may be undertaken linked to specific triggers, these actions and associations to triggering events may be stored in an action response library 562. For example, a trigger may include “Please send me the brochure.” This trigger may be linked to the action of attaching a brochure document to the response message, which may be actionable via a webhook or the like. The system may choose attachment materials from a defined library (SalesForce repository, etc.), driven by insights gained from parsing and classifying the previous response, or other knowledge obtained about the target, client, and conversation. Other actions could include initiating a purchase (order a pizza for delivery for example) or pre-starting an ancillary process with data known about the target (kick of an application for a car loan, with name, etc. already pre-filled in for example). Another action that is considered is the automated setting and confirmation of appointments.

The message delivery handler 560 may have a weighted phrase package selector 563 that incorporates phrase packages into a generated message based upon their common usage together, or by some other metric. Lastly, the message delivery handler 560 may operate to select which language to communicate using. Rather than perform classifications using full training sets for each language, as is the traditional mechanism, the systems leverage dictionaries for all supported languages, and translations to reduce the needed level of training sets, as noted above in relation to the translation system 550. In such systems, a primary language is selected, and a full training set is used to build a model for the classification using this language. Smaller training sets for the additional languages may be added into the machine learned model. These smaller sets may be less than half the size of a full training set, or even an order of magnitude smaller. When a response is received, it may be translated into all the supported languages, and this concatenation of the response may be processed for classification. The flip side of this analysis is the ability to alter the language in which new messages are generated. For example, if the system detects that a response is in French, the classification of the response may be performed in the above-mentioned manner, and similarly any additional messaging with this contact may be performed in French.

Determination of which language to use is easiest if the entire exchange is performed in a particular language. The system may default to this language for all future conversation. Likewise, an explicit request to converse in a particular language may be used to determine which language a conversation takes place in. However, when a message is not requesting a preferred language, and has multiple language elements, the system may query the user on a preferred language and conduct all future messaging using the preferred language.

A scheduler 565 used rules for messaging timing and learned behaviors in order to output the message at an appropriate time. For example, when emailing, humans generally have a latency in responding that varies from a few dozen minutes to a day or more. Having a message response sent out too quickly seems artificial. A response exceeding a couple of days, depending upon the context, may cause frustration, irrelevance, or may not be remembered by the other party. As such, the scheduler 565 aims to respond in a more ‘human’ timeframe and is designed to maximize a given conversation objective.

Turning now to the versioning controller 570, an example of a framework pipeline 579 is provided. The response framework is set up where each individual process or model is maintained distinctly from all other components in individually hosted docker containers. This architecture enables easy scale up of additional resources based upon system demands. The framework may thus be viewed as a communication protocol and system of orchestration that enables individual components to be chained together in a pipeline.

As individual components are updated, the most recent copy of the component is used in the pipeline. If for any reason there is an error in the newly updated component, the entire framework may experience instability as a result. By employing robust versioning and recovery activity, these risks of system instability can be minimized.

The system is designed where the sentence objects in the framework document schema contain unique text fields to store the output of every text-to-text transformation component. For example: a “text_ner” field to store the output from component “component_sentence_ner” and a “text_dlp” field to store the output from component “component_pii_redaction”. This has meant that the configuration of an individual component is highly dependent on the order of the components in a pipeline. For instance, in the default follow-up-series pipeline, the component “component_pii_redaction” reads from the “text_ner” field in the framework sentence objects. If a data scientist were to create a pipeline with the existing components, but with “component_pii_redaction” occurring before “component_sentence_ner”, the pipeline would fail, as the “text_ner” field would not have been created at the time it is being read.

FIG. 5G illustrates an example of this framework 579, where the framework document 571 includes and raw text field which is supplied to the name entity recognition (NER) component 575 for analysis. The result is a NER field 573 which is consumed by the data loss prevention (DLP) component 576, which generates the DLP field 574 with redacted personally identifiable information (PII) in this example. This example clearly illustrates how these components are “chained” to one another and are therefore interdependent.

Rather than the framework system breaking on encountering an exception, the exception is handled gracefully. Hard-coded defaults may be utilized in some cases where an exception occurs. In other situations, an exception may be automatically routed to the training desk. When robust versioning of changes are kept, the system may also be capable of reverting to the last known functioning framework upon exception detection, and alerting the data scientists to the exception existence to enable correction.

In addition to processing individual live responses, a subset of pre-processing components has shown promise for dataset creation. This was motivated by the need, as dataset requirements evolve, for consistency and reliability between training and live data, accomplished by utilizing a single implementation for both. However, using components according to their original design, processing archived responses one by one, is not a timely computational model. An additional endpoint on these components that accepts batches of responses to be processed in parallel has shown potential to balance performance with consistency.

### II. Methods

Now that the systems for dynamic messaging and natural language processing techniques have been broadly described, attention will be turned to processes employed to perform AI driven conversations with attendant actions and enhanced functionalities.

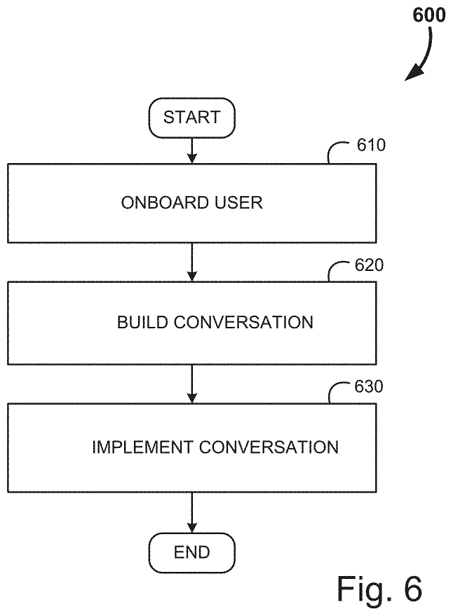

In FIG. 6 an example flow diagram for a dynamic message conversation is provided, shown generally at 600. The process can be broadly broken down into three portions: the on-boarding of a user (at 610), conversation generation (at 620) and conversation implementation (at 630). The following figures and associated disclosure will delve deeper into the specifics of these given process steps.

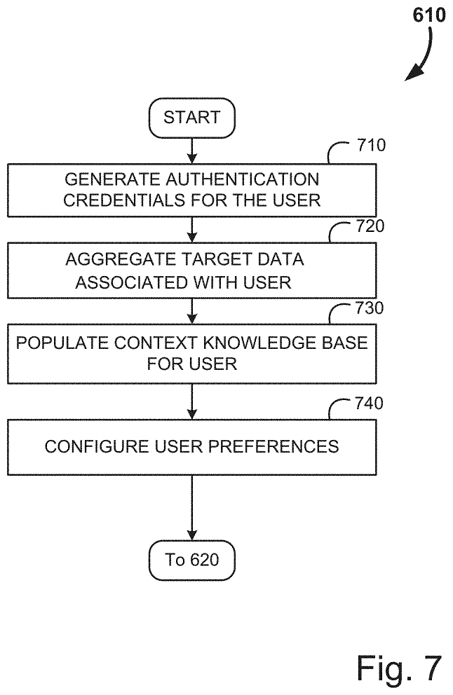

FIG. 7, for example, provides a more detailed look into the on-boarding process, shown generally at 610. Initially a user is provided (or generates) a set of authentication credentials (at 710). This enables subsequent authentication of the user by any known methods of authentication. This may include username and password combinations, biometric identification, device credentials, etc.

Next, the target data associated with the user is imported, or otherwise aggregated, to provide the system with a target database for message generation (at 720). Likewise, context knowledge data may be populated as it pertains to the user (at 730). Often there are general knowledge data sets that can be automatically associated with a new user; however, it is sometimes desirable to have knowledge sets that are unique to the user's conversation that wouldn't be commonly applied. These more specialized knowledge sets may be imported or added by the user directly.

Lastly, the user is able to configure their preferences and settings (at 740). This may be as simple as selecting dashboard layouts, to configuring confidence thresholds required before alerting the user for manual intervention.

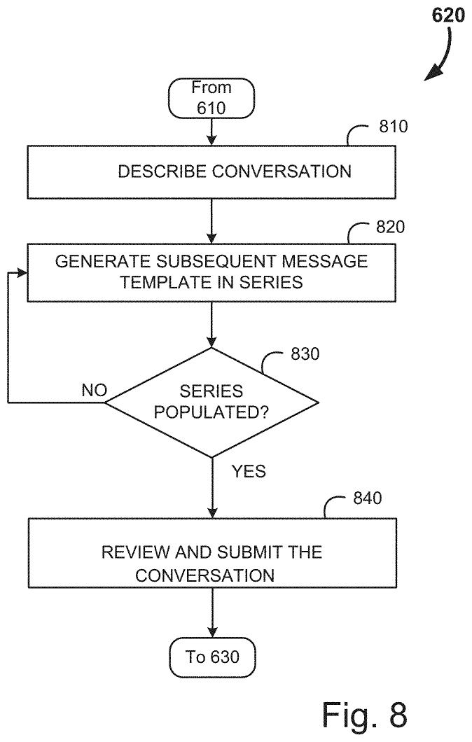

Moving on, FIG. 8 is the example flow diagram for the process of building a conversation, shown generally at 620. The user initiates the new conversation by first describing it (at 810). Conversation description includes providing a conversation name, description, industry selection, and service type. The industry selection and service type may be utilized to ensure the proper knowledge sets are relied upon for the analysis of responses.

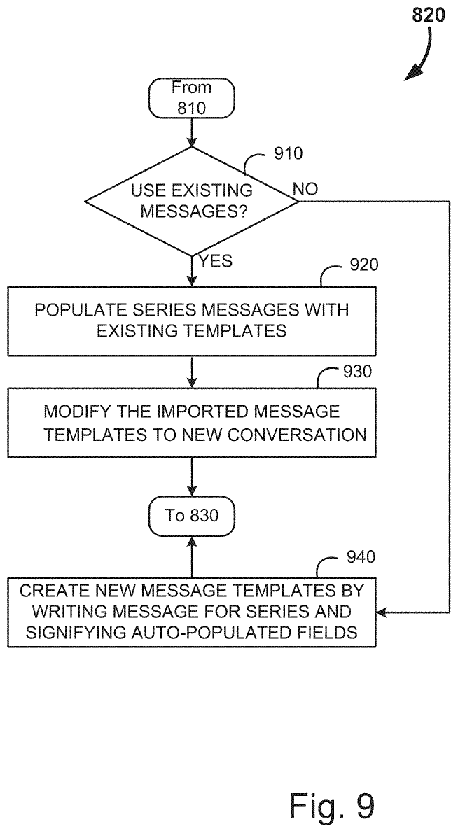

After the conversation is described, the message templates in the conversation are generated (at 820). If the series is populated (at 830), then the conversation is reviewed and submitted (at 840). Otherwise, the next message in the template is generated (at 820). FIG. 9 provides greater details of an example of this sub-process for generating message templates. Initially the user is queried if an existing conversation can be leveraged for templates, or whether a new template is desired (at 910).

If an existing conversation is used, the new message templates are generated by populating the templates with existing templates (at 920). The user is then afforded the opportunity to modify the message templates to better reflect the new conversation (at 930). Since the objectives of many conversations may be similar, the user will tend to generate a library of conversations and conversation fragments that may be reused, with or without modification, in some situations. Reusing conversations has time saving advantages, when it is possible.

However, if there is no suitable conversation to be leveraged, the user may opt to write the message templates from scratch using the Conversation Editor (at 940). When a message template is generated, the bulk of the message is written by the user, and variables are imported for regions of the message that will vary based upon the target data. Successful messages are designed to elicit responses that are readily classified. Higher classification accuracy enables the system to operate longer without user interference, which increases conversation efficiency and user workload.

Messaging conversations can be broken down into individual objectives for each target. Designing conversation objectives allows for a smoother transition between messaging series. Table 1 provides an example set of messaging objectives for a sales conversation.

TABLE 1
Template Objectives

| Series | Objective |
|---|---|
| 1 | Verify Email Address |
| 2 | Obtain Phone Number |
| 2 | Introduce Sales Representative |
| 3 | Verify Rep Follow-Up |

Likewise, conversations can have other arbitrary set of objectives as dictated by client preference, business function, business vertical, channel of communication and language. Objective definition can track the state of every target. Inserting personalized objectives allows immediate question answering at any point in the lifecycle of a target. The state of the conversation objectives can be tracked individually as shown below in reference to Table 2.

TABLE 2
Objective tracking

| Target | Conversation | | | | |
|---|---|---|---|---|---|
| ID | ID | Objective | Type | Pending | Complete |
| 100 | 1 | Verify Email Address | Q | 1 | 1 |
| 100 | 1 | Obtain Phone Number | Q | 0 | 1 |
| 100 | 1 | Give Location Details | I | 1 | 0 |
| 100 | 1 | Verify Rep Follow-Up | Q | 0 | 0 |

Table 2 displays the state of an individual target assigned to conversation 1, as an example. With this design, the state of individual objectives depends on messages sent and responses received. Objectives can be used with an informational template to make a series transition seamless. Tracking a target's objective completion allows for improved definition of target's state, and alternative approaches to conversation message building. Conversation objectives are not immediately required for dynamic message building implementation but become beneficial soon after the start of a conversation to assist in determining when to move forward in a series.

Dynamic message building design depends on ‘message_building’ rules in order to compose an outbound document. A Rules child class is built to gather applicable phrase components for an outbound message. Applicable phrases depend on target variables and target state.

To recap, to build a message, possible phrases are gathered for each template component in a template iteration. In some embodiment, a single phrase can be chosen randomly from possible phrases for each template component. Alternatively, as noted before, phrases are gathered and ranked by “relevance”. Each phrase can be thought of as a rule with conditions that determine whether or not the rule can apply and an action describing the phrase's content.

Relevance is calculated based on the number of passing conditions that correlate with a target's state. A single phrase is selected from a pool of most relevant phrases for each message component. Chosen phrases are then imploded to obtain an outbound message. Logic can be universal or data specific as desired for individual message components.

Variable replacement can occur on a per phrase basis, or after a message is composed. Post message-building validation can be integrated into a message-building class. All rules interaction will be maintained with a messaging rules model and user interface.

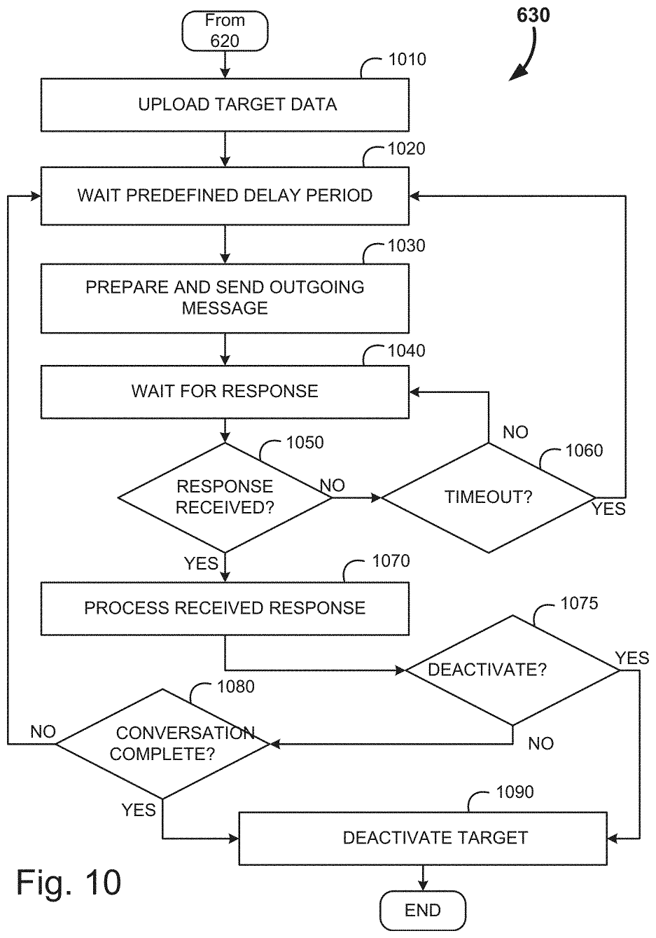

Once the conversation has been built out it is ready for implementation. FIG. 10 is an example flow diagram for the process of implementing the conversation, shown generally at 630. Here the lead (or target) data is uploaded (at 1010). Target data may include any number of data types, but commonly includes names, contact information, date of contact, item the target was interested in (in the context of a sales conversation), etc. Other data can include open comments that targets supplied to the target provider, any items the target may have to trade in, and the date the target came into the target provider's system. Often target data is specific to the industry, and individual users may have unique data that may be employed.

An appropriate delay period is allowed to elapse (at 1020) before the message is prepared and sent out (at 1030). The waiting period is important so that the target does not feel overly pressured, nor the user appears overly eager. Additionally, this delay more accurately mimics a human correspondence (rather than an instantaneous automated message). Additionally, as the system progresses and learns, the delay period may be optimized by a cadence optimizer to be ideally suited for the given message, objective, industry involved, and actor receiving the message.

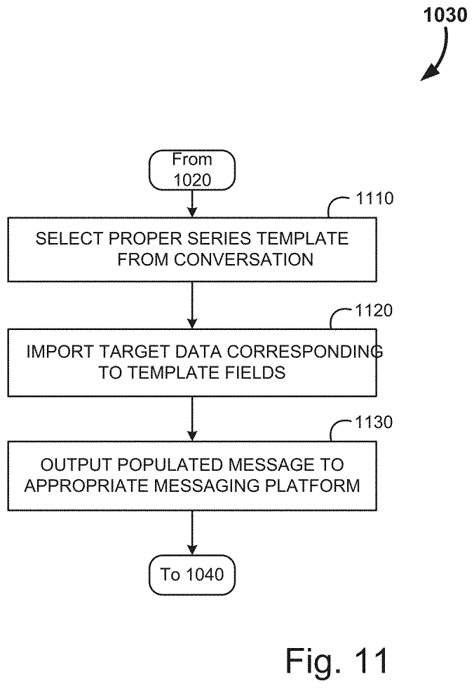

FIG. 11 provides a more detailed example of the message preparation and output. In this example flow diagram, the message within the series is selected based upon which objectives are outstanding (at 1110). Typically, the messages will be presented in a set order; however, if the objective for a particular target has already been met for a given series, then another message may be more appropriate. Likewise, if the recipient didn't respond as expected, or not at all, it may be desirous to have alternate message templates to address the target most effectively.

After the message template is selected from the series, the target data is parsed through, and matches for the variable fields in the message templates are populated (at 1120). Variable filed population, as touched upon earlier, is a complex process that may employ personality matching, and weighting of phrases or other inputs by success rankings. These methods will also be described in greater detail when discussed in relation to variable field population in the context of response generation. Such processes may be equally applicable to this initial population of variable fields.

In addition, or alternate to, personality matching or phrase weighting, selection of wording in a response could, in some embodiments, include matching wording or style of the conversation target. People, in normal conversation, often mirror each other's speech patterns, mannerisms and diction. This is a natural process, and an AI system that similarly incorporates a degree of mimicry results in a more ‘humanlike’ exchange.

Additionally, messaging may be altered by the class of the audience (rather than information related to a specific target personality). For example, the system may address an enterprise customer differently than an individual consumer. Likewise, consumers of one type of good or service may be addressed in subtly different ways than other customers. Likewise, a customer service assistant may have a different tone than an HR assistant, etc.

The populated message is output to the communication channel appropriate messaging platform (at 1130), which as previously discussed typically includes an email service, but may also include SMS services, instant messages, social networks, audio networks using telephony or speakers and microphone, or video communication devices or networks or the like. In some embodiments, the contact receiving the messages may be asked if he has a preferred channel of communication. If so, the channel selected may be utilized for all future communication with the contact. In other embodiments, communication may occur across multiple different communication channels based upon historical efficacy and/or user preference. For example, in some particular situations a contact may indicate a preference for email communication. However, historically, in this example, it has been found that objectives are met more frequently when telephone messages are utilized. In this example, the system may be configured to initially use email messaging with the contact, and only if the contact becomes unresponsive is a phone call utilized to spur the conversation forward. In another embodiment, the system may randomize the channel employed with a given contact, and over time adapt to utilize the channel that is found to be most effective for the given contact.

Returning to FIG. 10, after the message has been output, the process waits for a response (at 1040). If a response is not received (at 1050) the process determines if the wait has been timed out (at 1060). Allowing a target to languish too long may result in missed opportunities; however, pestering the target too frequently may have an adverse impact on the relationship. As such, this timeout period may be user defined and will typically depend on the communication channel. Often the timeout period varies substantially, for example for email communication the timeout period could vary from a few days to a week or more. For real-time chat communication channel implementations, the timeout period could be measured in seconds, and for voice or video communication channel implementations, the timeout could be measured in fractions of a second to seconds. If there has not been a timeout event, then the system continues to wait for a response (at 1050). However, once sufficient time has passed without a response, it may be desirous to return to the delay period (at 1020) and send a follow-up message (at 1030). Often there will be available reminder templates designed for just such a circumstance.

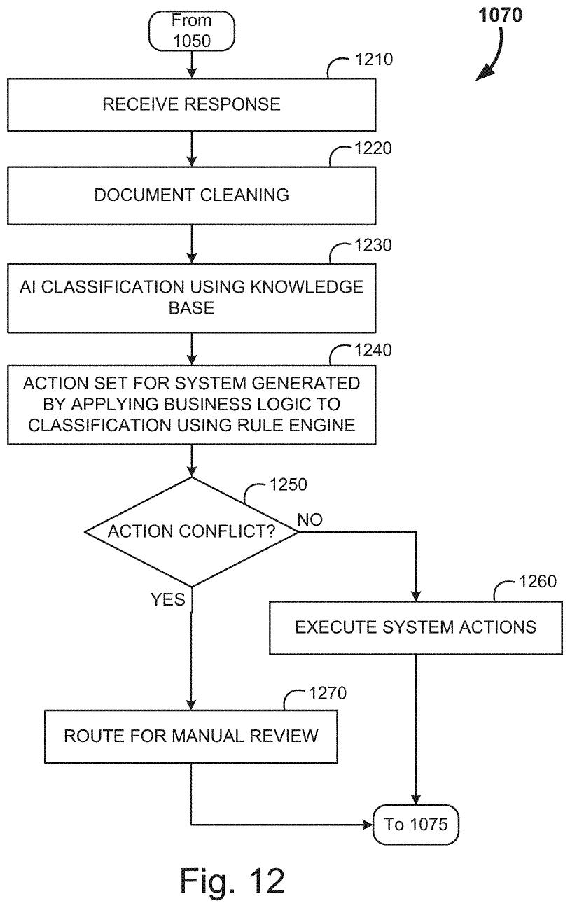

However, if a response is received, the process may continue with the response being processed (at 1070). This processing of the response is described in further detail in relation to FIG. 12. In this sub-process, the response is initially received (at 1210) and the document may be cleaned (at 1220). For example, for an email, adapters may exist for the subject and body of the response, often a number of elements need to be removed, including the original message, HTML encoding for HTML style responses, enforce UTF-8 encoding so as to get diacritics and other notation from other languages, and signatures so as to not confuse the AI. An initial step of the document preprocessing/cleaning process is the parsing of the document into constituent portions. As discussed previously, this may include breaking the raw text of the message into a salutation, body/reply, close, signature and other category. This process includes the removal of outgoing message components, preprocessing text and build features, as previously discussed, and asking for predictions.

The body portion of the response may be split into individual sentences by a sentence splitter. This is performed because generally each sentence of a conversation includes a separate/discrete idea or intention. By separating each sentence the risk of token contamination between the sentences is reduced.

The documents may further be processed through lemmatization, the creation of n-grams, noun-phrase identification, and extraction of out-of-office features. Each of these steps may be considered a feature extraction of the document. Historically, extractions have been combined in various ways, which results in an exponential increase in combinations as more features are desired. In response, the present method performs each feature extraction in discrete steps (on an atomic level) and the extractions can be “chained” as desired to extract a specific feature set.

Returning to FIG. 12, after document cleaning, the document is then provided to the AI platform for classification using the knowledge sets/base (at 1230). For the purpose of this disclosure, a “knowledge set” is a corpus of domain specific information that may be leveraged by the machine learned classification models. The knowledge sets may include a plurality of concepts and relationships between these concepts. It may also include basic concept-action pairings. The AI Platform will apply large knowledge sets to classify ‘Continue Messaging’, ‘Do Not Email’ and ‘Send Alert’ insights. Additionally, various domain specific ‘micro-insights’ can use smaller concise knowledge sets to search for distinct elements in responses.

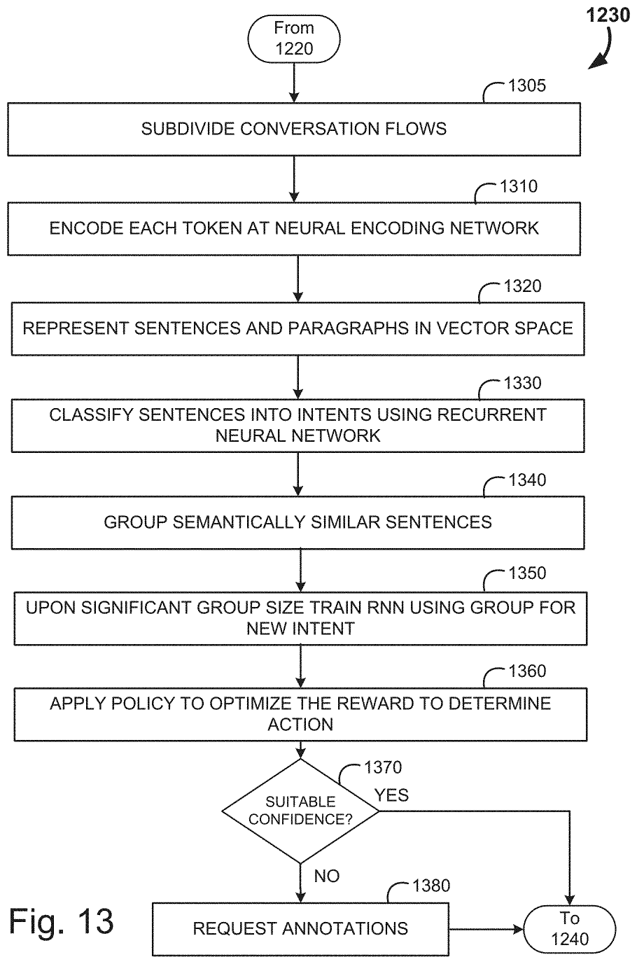

FIG. 13 provides a more detailed view of the classification step 1230. As previously touched upon, this includes subdividing the conversation flows (at 1305) based upon the reason for communication, target goal and objective of the conversation, and sets of key verbiage supplied by the customer to help personalize the outreach effort. Conversation flows may then be further subdivided based upon their business function.

Subsequently, each token of the response is encoded at the neural encoding network (at 1310). The neural encoding network may employ word embedding models to encode each token into a vector in a dense high-dimensional vector space (e.g., 300 or more dimensions). Likewise, sentences and paragraphs may be likewise encoded in the vector space (at 1320). These encodings are then provided to four models, the first may include extraction of name entities across all the sentences. The system may also perform extraction of redact information, as needed. For example, given the importance of privacy regulations in modern business, certain information that is deemed “personally identifiable information” (PII) may be identified within the named entities and redacted accordingly. The redactions objects and the entity objects are similar to one another, and may be combined into a single field with an attendant ‘source’ label indicating whether the object is an entity or a redaction.

For the entity and redaction recognition the input includes the raw text, target and name information. The output is a sentence text with entity tokens replaced with labels, and a listing of the entities. Entities may include names, products, businesses/organizations, places, named events, phone numbers, email addresses and the like. Following the entity extraction the PII redaction may be performed. The output resulting is a redacted text, listing of sentence entities, subject text redacted, and subject text entity listings. Examples of data that may be redacted include email addresses, phone numbers, ages, credit card numbers, names, locations, IP addresses, MAC addresses, hardware IDs and the like.

The second model employed includes a recurrent neural network (RNN) which classifies intents at a paragraph level. The third model is a different RNN that classifies individual sentences into intents (at 1330). The sentence-level intents and paragraph-level intents share the taxonomy but have a distinct set of labels.

Lastly, a K-nearest neighbor algorithm is used on sentence representations to group them into semantically similar groups (at 1340). When a cluster of semantically similar groups is big enough, the system may train the corresponding RNN model for the groups and create a new sentence intent RNN network and add it the set of sentence intents if bias and variance are low (at 1350).

The outputs of each of the above models represent the state of the environment that is then shared with the agent in a reinforcement learning setting. The agent applies a policy to optimize for an objective reward and determine the action (at 1360). If the action cannot be determined with a suitable degree of confidence (at 1370), the process may institute an annotation procedure (at 1380).

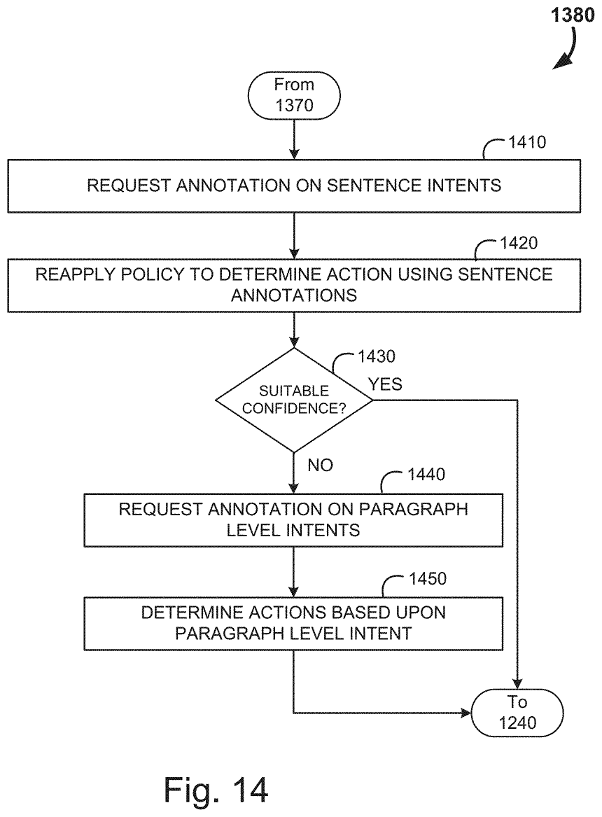

FIG. 14 provides a more detailed flow diagram of one example process for such annotations. Initially, annotations are requested at the sentence level (at 1410). Policies may be reapplied to determine the sentence intents using the newly added annotation information (at 1420). Again a check is made if the action can be determined with suitable confidence given the new sentence annotations (at 1430). If so, the annotation process may conclude, but if not then the system may request annotations on the paragraph level (at 1440). These paragraph level annotations are then leveraged to determine the intent on a less-granular paragraph level (at 1460). Annotations are organized into an annotation queue with an attendant priority setting. Annotations are then processed, in order of priority, by a human annotator, utilizing a web application annotation tool. The queue can be embodied as a SQL table, in some cases.

Annotations may include specific transition annotations, which require domain specific knowledge, are applicable to only the present exchange, but require less manual input. Annotations may also include annotation of intents and entity values. Such annotations do not require domain specific knowledge, are applicable across any exchange where these intents and entities are present, but require more manual input. The type of annotation desired may vary based upon if the use case is at a system level or at a client level, in some embodiments.

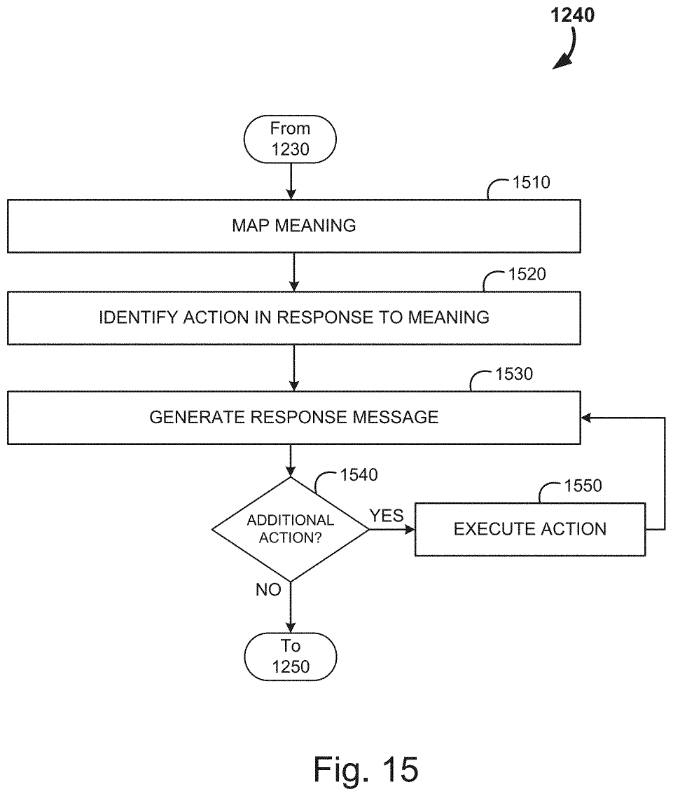

Returning to FIG. 12, after intent classification has been performed, actions may be set by application of business logic (policies) to the classification (at 1240) as touched upon in the earlier figures. This sub process is described in greater detail in relation to FIG. 15. A critical component of action determination is to map the intents predicted during classification to meanings (at 1510). The meaning or intent is then used to identify an action (at 1520) using a nested Boolean expression, hierarchy of intents, policy gradient algorithms such as A3C, value iteration algorithms such as Double Deep Q-Learning Networks, and other reinforcement learning algorithms (for sentence level intents). Paragraph level intents are fewer in number and may be mapped to actions using simple conjunctive or disjunctive Boolean expression without nesting.

This response is generated (at 1530) by identifying an appropriate response template, and populating the variable fields within the template. Population of the variable fields includes replacement of facts and entity fields from the conversation library based upon an inheritance hierarchy. The conversation library is curated and includes specific rules for inheritance along organization levels and degree of access. This results in the insertion of customer/industry specific values at specific place in the outgoing messages, as well as employing different lexica or jargon for different industries or clients. Wording and structure may also be influenced by defined conversation objectives and/or specific data or properties of the specific target.

Specific phrases may be selected based upon weighted outcomes (success ranks). The system calculates phrase relevance scores to determine the most relevant phrases given a lead state, sending template, and message component. Some (not all) of the attributes used to describe lead state are: the client, the conversation, the objective (primary versus secondary objective), series in the conversation, and attempt number in the series, insights, target language and target variables. For each message component, the builder filters (potentially thousands of) phrases to obtain a set of maximum-relevance candidates. In some embodiments, within this set of maximum-relevance candidates, a single phrase is randomly selected to satisfy a message component. As feedback is collected, phrase selection is impacted by phrase performance over time, as discussed previously. In some embodiments, every phrase selected for an outgoing message is logged. Sent phrases are aggregated into daily windows by Client, Conversation, Series, and Attempt. When a response is received, phrases in the last outgoing message are tagged as ‘engaged’. When a positive response triggers another outgoing message, the previous sent phrases are tagged as ‘continue’. The following metrics are aggregated into daily windows: total sent, total engaged, total continue, engage ratio, and continue ratio.

To impact message-building, phrase performance must be quantified and calculated for each phrase. This may be performed using the following equation:

$$Phrase performance \\ performance = \frac{( percent\_engaged + percent\_continue )}{2} \qquad Equation 1$$

Engagement and continuation percentages are gathered based on messages sent within the last 90 days, or some other predefined history period. Performance calculations enable performance-driven phrase selection. Relative scores within maximum-relevance phrases can be used to calculate a selection distribution in place of random distribution.

Phrase performance can fluctuate significantly when sending volume is low. To minimize error at low sending volumes, a

$$\frac{ln ( x )}{x}$$

padding window is applied to augment all phrase-performance scores. The padding is effectively zero when total_sent is larger than 1,500 sent messages. This padded performance is performed using the following equation:

$$Padded performance \\ performance\_pad = 100 \times \frac{ln ( total\_sent + LN\_OFFSET )}{total\_sent + ZERO\_OFFSET} \qquad Equation 2$$

Performance scores are augmented with the performance pad prior to calculating distribution weights using the following equation:

performance′=performance+performance_pad Equation 3: Augmented phrase performance

As noted, phrase performance may be calculated based on metrics gathered in the last 90 days. That window can change to alter selection behavior. Weighting of metrics may also be based on time. For example, metrics gathered in the last 30 days may be assigned a different weight than metrics gathered in the last 30-60 days. Weighting metrics based on time may affect selection behaviors as well. Phrases can be shared across client, conversation series, attempt, etc. It should be noted that alternate mechanisms for calculating phrase performance are also possible, such as King of the Hill or Reinforcement Learning, deep learning, etc.

Due to the fact that message attempt is correlated with engagement; metrics are gathered per attempt to avoid introducing engagement bias. Additionally, variable values can impact phrase performance; thus, calculating metrics per client is done to avoid introducing variable value bias.

Adding performance calculations to message building increases the amount of time to build a single message. System improvements are required to offset this additional time requirement. These may include caching performance data to minimize redundant database queries, aggregating performance data into windows larger than one day, and aggregating performance values to minimize calculations made at runtime.

In addition to performance-based selection, as discussed above, phrase selection may be influenced by the “personality” of the system for the given conversation. Personality of an AI assistant may not just be set, as discussed previously, but may likewise be learned using machine learning techniques that determines what personality traits are desirable to achieve a particular goal, or that generally has more favorable results.

Message phrase packages are constructed to be tone, cadence, and timbre consistent throughout, and are tagged with descriptions of these traits (professional, firm, casual, friendly, etc.), using standard methods from cognitive psychology. Additionally, in some embodiments, each phrase may include a matrix of metadata that quantifies the degree a particular phrase applies to each of the traits. The system will then map these traits to the correct set of descriptions of the phrase packages and enable the correct packages. This will allow customers or consultants to more easily get exactly the right Assistant personality (or conversation personality) for their company, particular target, and conversation. This may then be compared to the identity personality profile, and the phrases which are most similar to the personality may be preferentially chosen, in combination with the phrase performance metrics. A random element may additionally be incorporated in some circumstances to add phrase selection variability and/or continued phrase performance measurement accuracy. After phrase selection, the phrases replace the variables in the template. The completed templates are then output as a response. The system may determine if additional actions are needed (at 1540), which may include attaching documents, setting calendar appointments, inclusion of web hooks, or similar activities (at 1550).

Returning all the way back to FIG. 12, after the actions are generated, a determination is made whether there is an action conflict (at 1250). Manual review may be needed when such a conflict exists (at 1270). Otherwise, the actions may be executed by the system (at 1260).

Returning then to FIG. 10, after the response has been processed, a determination is made whether to deactivate the target (at 1075). Such a deactivation may be determined as needed when the target requests it. If so, then the target is deactivated (at 1090). If not, the process continues by determining if the conversation for the given target is complete (at 1080). The conversation may be completed when all objectives for the target have been met, or when there are no longer messages in the series that are applicable to the given target. Once the conversation is completed, the target may likewise be deactivated (at 1090).

However, if the conversation is not yet complete, the process may return to the delay period (at 1020) before preparing and sending out the next message in the series (at 1030). The process iterates in this manner until the target requests deactivation, or until all objectives are met. This concludes the main process for a comprehensive messaging conversation.

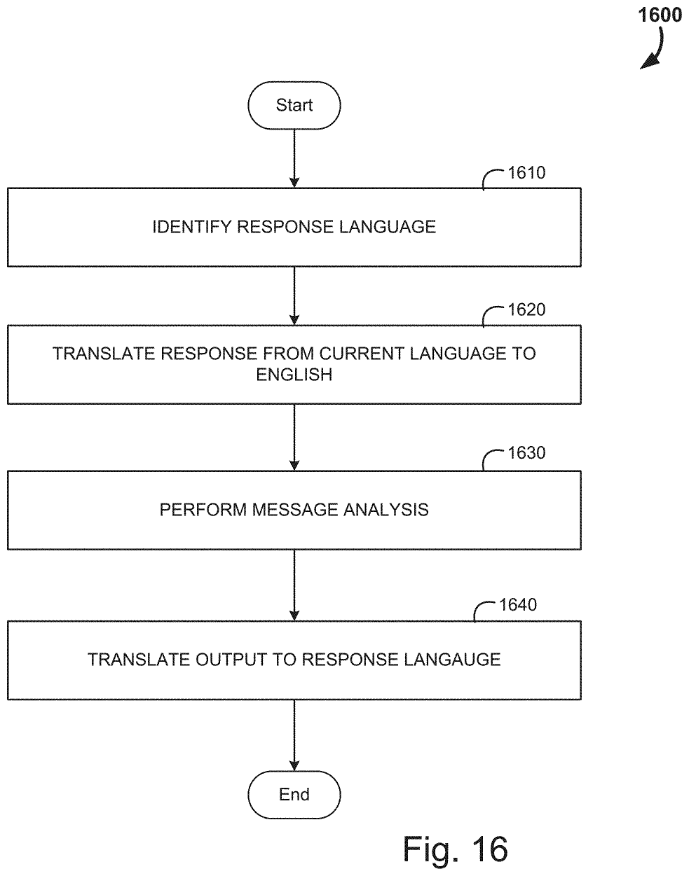

Turning now to FIG. 16, an example process flow diagram is provided for the method of automated conversation in an alternate language (as opposed to the primary operating language), shown generally at 1600. It should be noted that the presently discloses systems are discussed in terms of being implemented in English as the primary language, and translated into alternate languages as required. However, if implemented by developers in another region of the world, it is probable that the primary language of deployment could be another language that is not English, such as German, Spanish, Mandarin, Cantonese, Russian, French, Korean, Japanese or any other language. The primary decider of which language is “primary” depends heavily upon which language is used to predominantly train the models employed to classify the response, and the language used for the mapping models/policies/rules to generate the corresponding actions. It is thus intended that the present disclosure that centers on English as the primary language to be merely illustrative, and the teachings herein would apply equally well to other primary language substantiations.

Initially the method determines which language the response is received in (at 1610). In most cases, this identification process is relatively straight forward. It becomes more difficult when the language used by the target is badly written, includes significant slang, or is hybridized between two or more languages. In situations where known language identification algorithms are incapable of determining the language used with a high degree of confidence, the response may be sub-divided, first by sentences and then by n-grams if needed, for identification. Especially in hybrid-language responses there is a tendency that individual sentences are composed in a single language, even if each sentence may alternate between different languages. Only when sentence level language detection fails are individual words or clusters of words individually compared against dictionaries to determine language of use.

The response is then translated from the current language to English, or other primary language (at 1620). As with the language identification, known methods of translation are known and may be employed for this process. In some embodiments, a number of alternate translation models may be available, and may be selected based upon their accuracy in light of the response flow. For example, within a particular conversation type, industry discussion, and context, a particular model may be preferable over some other model. In an alternate context, other models may have been shown to be historically more accurate, and may be relied upon instead.

The message analysis is then performed, in much the manner disclosed above in relation to FIGS. 6-15, on the translated response (at 1630). One unique aspect of this processing is that particular intent models may be afforded higher weights, or may be preferentially utilized, based upon the translation that was previously employed. For example, if sentence level intents can be identified by three different recurrent neural networks, the system typically will operate all models in parallel and select the intent of the highest confidence model, or the models that are in agreement. However, it may be determined that particular models, that may not regularly provide the highest confidence classification, may be particularly adept for the classification of particular translations. Thus, this model may be relied upon more heavily based upon the translation performed, despite perhaps having a lower confidence as compared to the classification of an alternate model.

After the process concludes with the return message being generated, this response may be translated back into the original language (at 1640) before being outputted to the target. By undergoing this translation back and forth, the system may rely upon the models that have the largest training databases available. Despite the added error introduced by the translations, the classification process and action determination is significantly more accurate using well trained models. Further, as the systems improve as more conversations occur, by consolidating all conversations into common modeling processes, all conversations are able to benefit from the exchange when commonly processed.

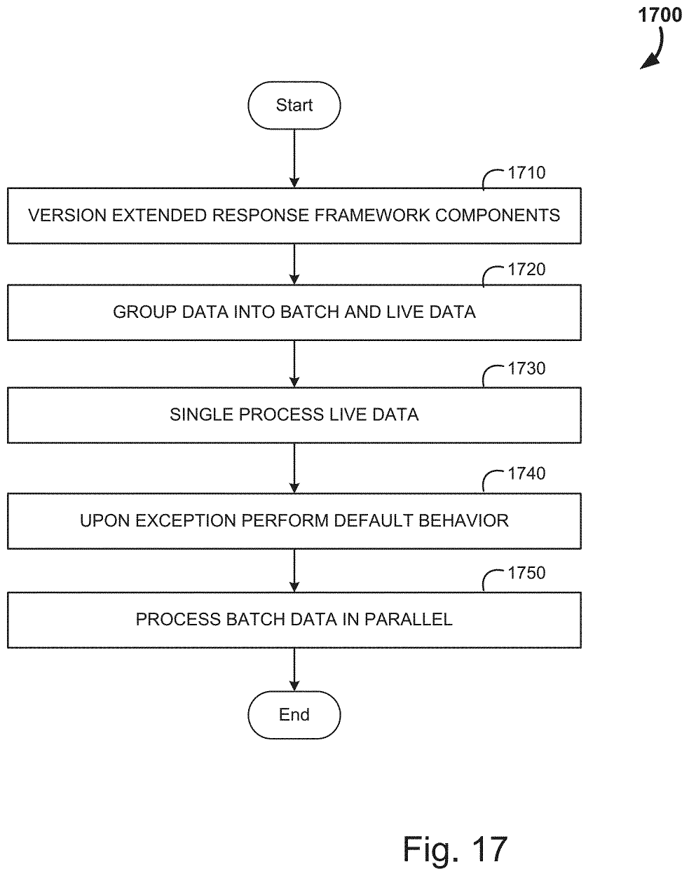

Turning now to FIG. 17, a flow diagram is provided for an example process for version controlling the system as it is updated, shown generally at 1700. Initially the extended response framework components are versioned (at 1710) with a date tag as they are implemented. Data is then grouped into either batch processing or live data sets (at 1720). Live data is processed in the fashion described in FIG. 6-15 on an individual basis using the most recent version of each component in the framework (at 1730). When exceptions are experienced, the system may revert to the prior version of the framework (at 1740) to ensure the processing is completed without any disruption. The exception is noted so that it can be corrected in a timely manner. This allows only operational versions to be used when parallel processing of batch datasets (at 1750). Parallel processing of this data allows for balance between performance and consistency between training and live data.

### III. System Embodiments

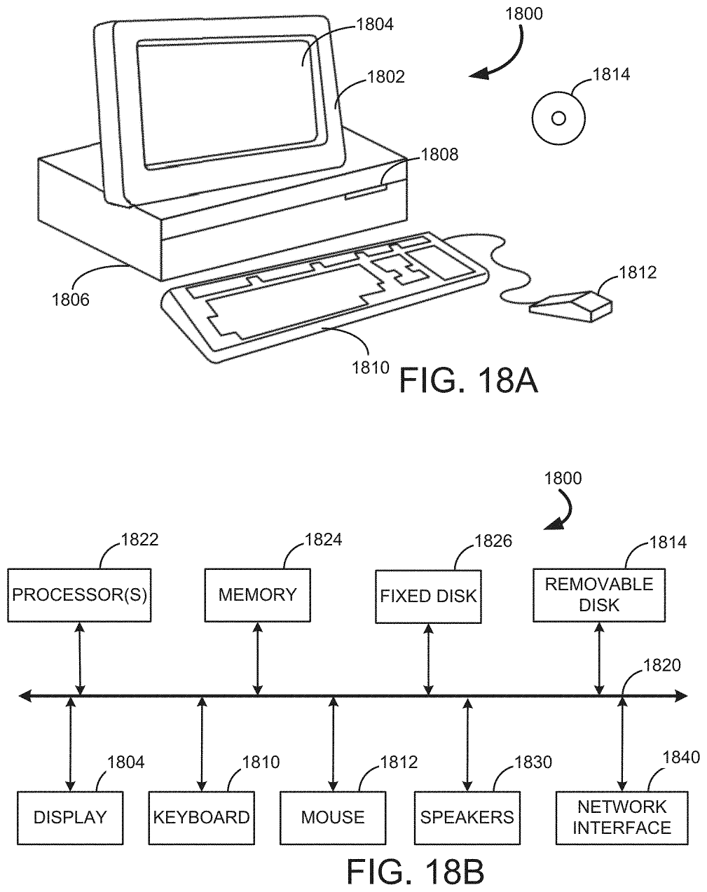

Now that the systems and methods for the conversation generation with improved functionalities have been described, attention shall now be focused upon systems capable of executing the above functions. To facilitate this discussion, FIGS. 18A and 18B illustrate a Computer System 1800, which is suitable for implementing embodiments of the present invention. FIG. 18A shows one possible physical form of the Computer System 1800. Of course, the Computer System 1800 may have many physical forms ranging from a printed circuit board, an integrated circuit, and a small handheld device up to a huge super computer. Computer system 1800 may include a Monitor 1802, a Display 1804, a Housing 1806, a Storage Drive 1808, a Keyboard 1810, and a Mouse 1812. Storage 1814 is a computer-readable medium used to transfer data to and from Computer System 1800.

FIG. 18B is an example of a block diagram for Computer System 1800. Attached to System Bus 1820 are a wide variety of subsystems. Processor(s) 1822 (also referred to as central processing units, or CPUs) are coupled to storage devices, including Memory 1824. Memory 1824 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Storage 1826 may also be coupled bi-directionally to the Processor 1822; it provides additional data storage capacity and may also include any of the computer-readable media described below. Fixed Storage 1826 may be used to store programs, data, and the like and is typically a secondary storage medium (such as a hard disk) that is slower than primary storage. It will be appreciated that the information retained within Fixed Storage 1826 may, in appropriate cases, be incorporated in standard fashion as virtual memory in Memory 1824. Removable Storage 1814 may take the form of any of the computer-readable media described below.

Processor 1822 is also coupled to a variety of input/output devices, such as Display 1804, Keyboard 1810, Mouse 1812 and Speakers 1830. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1822 optionally may be coupled to another computer or telecommunications network using Network Interface 1840. With such a Network Interface 1840, it is contemplated that the Processor 1822 might receive information from the network or might output information to the network in the course of performing the above-described dynamic messaging processes. Furthermore, method embodiments of the present invention may execute solely upon Processor 1822 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 1800 can be controlled by operating system software that includes a file management system, such as a storage operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a virtual machine, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for generating intents for a response comprising:
fixing a number of embeddings;
encoding each token of the response in a dense vector space with dimensions equal to the number of embeddings as a plurality of vectors;
extracting name entities using the plurality of vectors;
classifying individual sentences for the responses using the plurality of vectors to generate sentence level intents; and
classifying individual paragraphs for the responses using the plurality of vectors to generate paragraph level intents.

2. The method of claim 1, wherein the number of embeddings are fixed at or more than 300.

3. The method of claim 1, further comprising extending a network to represent sentences and paragraphs of the response in the vector space.

4. The method of claim 1, wherein the classifying the sentence level intents uses a first recurrent neural network (RNN), and the classifying the paragraph level intents uses a second RNN.

5. The method of claim 4, wherein the first RNN and second RNN use Bi-directional Long Short Term Memory (Bi-LSTM).

6. The method of claim 1, wherein the encoding the tokens utilizes at least one of CBOW, Skip-gram and Universal language models.

7. The method of claim 1, wherein the named entities are extracted using a RNN.

8. The method of claim 1, further comprising grouping sentences that are semantically similar.

9. The method of claim 8, wherein the grouping uses a K-nearest neighbor algorithm.

10. The method of claim 8, further comprising training a recurrent neural network for classifying the sentence level intents using the grouping of sentences above a threshold number.

11. A system for generating intents for a response comprising:
an encoder for encoding each token of the response in a dense vector space with dimensions equal to at least 300 as a plurality of vectors, and representing sentences and paragraphs of the response in the dense vector space;
a plurality of models for performing at least one of extracting name entities using the plurality of vectors, classifying individual sentences for the responses using the plurality of vectors to generate sentence level intents, and classifying individual paragraphs for the responses using the plurality of vectors to generate paragraph level intents.

12. The system of claim 11, wherein the classifying the sentence level intents uses a first recurrent neural network (RNN), and the classifying the paragraph level intents uses a second RNN.

13. The system of claim 12, wherein the first RNN and second RNN use Bi-directional Long Short Term Memory (Bi-LSTM).

14. The system of claim 11, wherein the encoding the tokens utilizes at least one of CBOW, Skip-gram and Universal language models.

15. The system of claim 11, wherein the named entities are extracted using a RNN.

16. The system of claim 11, further comprising a fourth modeling component for grouping sentences that are semantically similar.

17. The system of claim 16, wherein the grouping uses a K-nearest neighbor algorithm.

18. The system of claim 16, wherein the second modeling component further trains a recurrent neural network for classifying the sentence level intents using the grouping of sentences above a threshold number.

19. A method for generating actions for a response comprising:
receiving name entities, sentence level intents and paragraph level intents for the response;
receiving a policy for a conversation; and
optimizing a reward for the policy using the name entities, sentence level intents and paragraph level intents to generate an action.

20. The method of claim 19. wherein the action is determined for the sentence level intents through at least one of a nested Boolean expression, hierarchy of intents, policy gradient algorithms, value iteration algorithms, and reinforcement learning algorithms.
